(19) United States
(12) Patent Application Publication
(10) Pub. No.: US 2026/0239412 A1
(43) Pub. Date: Aug. 13, 2026

(54) USER EQUIPMENTS, AND COMMUNICATION METHODS

(71) Applicant: SHARP KABUSHIKI KAISHA, Sakai City, Osaka (JP)

(72) Inventors: LIQING LIU, Sakai City, Osaka (JP); DAIICHIRO NAKASHIMA, Sakai City, Osaka (JP); WATARU OUCHI, Sakai City, Osaka (JP); SHOICHI SUZUKI, Sakai City, Osaka (JP); Ryunosuke SAKAMOTO, Sakai City, Osaka (JP)

(21) Appl. No.: 19/155,714

(22) PCT Filed: Feb. 9, 2024
(86) PCT No.: PCT/JP2024/080016

§ 371 Date: Aug. 12, 2025

(30) Foreign Application Priority Data
Feb. 16, 2023 (JP) 2023-022250

(51) Int. Cl. H04W 72/563; H04B 7/06; H04B 17/318; H04W 72/40

(52) U.S. Cl. CPC H04W 72/563; H04B 7/0626; H04B 7/0632; H04B 17/328; H04W 72/40

(57) ABSTRACT

A method by a user equipment (UE) is described. The method includes performing a sidelink (SL) logical channel prioritization procedure; and determining, in the SL logical channel prioritization procedure, a priority order between a first SL CSI reporting Medium Access Control Element (MAC CE) and a second SL CSI reporting MAC CE, the first SL CSI reporting MAC CE carrying channel quality indicator (CQI) and rank indicator (RI) and the second SL CSI reporting MAC CE carrying at least a report quantity other than the CQI and the RI, wherein the second SL CSI reporting MAC CE is prioritized over the first SL CSI reporting MAC CE.

### TECHNICAL FIELD

The present disclosure relates to a user equipment, and a communication method.

### BACKGROUND ART

At present, as a radio access system and a radio network technology aimed for the fifth generation cellular system, technical investigation and standard development are being conducted, as extended standards of Long Term Evolution (LTE), on LTE-Advanced Pro (LTE-A Pro) and New Radio technology (NR) in The Third Generation Partnership Project (3GPP).

In the fifth generation cellular system, three services of enhanced Mobile BroadBand (eMBB) to achieve high-speed and large-volume transmission, Ultra-Reliable and Low Latency Communication (URLLC) to achieve low-latency and high-reliability communication, and massive Machine Type Communication (mMTC) to allow connection of a large number of machine type devices such as Internet of Things (IoT) have been demanded as assumed scenarios.

For example, wireless communication devices may communicate with one or more devices. For sidelink communication, two communication devices can communicate with each other via PC5 interface. For sidelink operation on FR2 licensed spectrum, supporting sidelink beam management is under discussion. However, the existing sidelink communication methods on sidelink CSI reporting cannot directly applied to the sidelink operation on FR2 licensed spectrum so that the flexibility and the efficiency of the whole sidelink communication system on FR2 licensed spectrum would be limited. As illustrated by this discussion, systems and methods, according to the present invention, supporting CSI reporting for sidelink operation on FR2 licensed spectrum, can improve the sidelink communication flexibility and/or efficiency.

### BRIEF DESCRIPTION OF THE DRAWINGS

FIG. 1 is a block diagram illustrating one configuration of one or more base stations and one or more user equipments (UEs) in which systems and methods for determination of sidelink CSI reporting for sidelink operation on FR2 licensed spectrum may be implemented;

FIG. 2 is a diagram illustrating one example 200 of a resource grid;

FIG. 3 is a diagram illustrating one example 300 of common resource block grid, carrier configuration and BWP configuration by a UE 102 and a base station 160;

FIG. 4 is a diagram illustrating one 400 example of CORESET configuration in a BWP by a UE 102 and a base station 160;

FIG. 5 is a diagram illustrating one example 500 of a SL BWP and a resource pool within the SL BWP;

FIG. 6 is a diagram illustrating one example 600 of a resource pool configuration;

FIG. 7 is a flow diagram illustrating one implementation of a method 700 for determination of CSI reporting by a UE 102;

FIG. 8 is a diagram illustrating examples 800 of MAC CEs for sidelink CSI reporting;

FIG. 9 is a diagram illustrating one implementation of a method 900 for priority determination for two sidelink CSI reporting MAC CEs by a UE 102;

FIG. 10 illustrates various components that may be utilized in a UE;

FIG. 11 illustrates various components that may be utilized in a base station.

### DESCRIPTION OF EMBODIMENTS

A user equipment (UE) is described. The UE includes a processor and a memory configured to, perform a sidelink (SL) logical channel prioritization procedure, and, determine, in the SL logical channel prioritization procedure, a priority order between a first SL CSI reporting Medium Access Control Element (MAC CE) and a second SL CSI reporting MAC CE, the first SL CSI reporting MAC CE carrying channel quality indicator (CQI) and rank indicator (RI) and the second SL CSI reporting MAC CE carrying at least a report quantity other than the CQI and the RI, wherein the second SL CSI reporting MAC CE is prioritized over the first SL CSI reporting MAC CE.

A communication method by a user equipment (UE) is described. The method includes performing a sidelink (SL) logical channel prioritization procedure; and determining, in the SL logical channel prioritization procedure, a priority order between a first SL CSI reporting Medium Access Control Element (MAC CE) and a second SL CSI reporting MAC CE, the first SL CSI reporting MAC CE carrying channel quality indicator (CQI) and rank indicator (RI) and the second SL CSI reporting MAC CE carrying at least a report quantity other than the CQI and the RI, wherein the second SL CSI reporting MAC CE is prioritized over the first SL CSI reporting MAC CE.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN). 3GPP NR (New Radio) is the name given to a project to improve the LTE mobile phone or device standard to cope with future requirements. In one aspect, LTE has been modified to provide support and specification (TS 38.211, 38.212, 38.213, 38.214, etc.) for the New Radio Access (NR) and Next generation-Radio Access Network (NG-RAN).

At least some aspects of the systems and methods disclosed herein may be described in relation to the 3GPP LTE, LTE-Advanced (LTE-A), LTE-Advanced Pro, New Radio Access (NR), and other 3G/4G/5G standards (e.g., 3GPP Releases 8, 9, 10, 11, 12, 13, 14, 15, 16, 17, and/or 18, and/or Narrow Band-Internet of Things (NB-IoT)). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE (User Equipment), an access terminal, a subscriber station, a mobile terminal, a remote station, a user terminal, a terminal, a subscriber unit, a mobile device, a relay node, etc. Examples of wireless communication devices include cellular phones, smart phones, personal digital assistants (PDAs), laptop computers, netbooks, e-readers, wireless modems, industrial wireless sensors, video surveillance, wearables, vehicles, roadside units, infrastructure devices, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.”

In 3GPP specifications, a base station is typically referred to as a gNB, a Node B, an eNB, a home enhanced or evolved Node B (HeNB) or some other similar terminology. As the scope of the disclosure should not be limited to 3GPP standards, the terms “base station,”, “gNB”, “Node B,” “eNB,” and “HeNB” may be used interchangeably herein to mean the more general term “base station.” Furthermore, one example of a “base station” is an access point. An access point may be an electronic device that provides access to a network (e.g., Local Area Network (LAN), the Internet, etc.) for wireless communication devices. The term “communication device” may be used to denote both a wireless communication device and/or a base station.

It should be noted that as used herein, a “cell” may be any communication channel that is specified by standardization or regulatory bodies to be used for International Mobile Telecommunications-Advanced (IMT-Advanced), IMT-2020 (5G) and all of it or a subset of it may be adopted by 3GPP as licensed bands (e.g., frequency bands) to be used for communication between a base station and a UE. It should also be noted that in NR, NG-RAN, E-UTRA and E-UTRAN overall description, as used herein, a “cell” may be defined as “combination of downlink and optionally uplink resources.” The linking between the carrier frequency of the downlink resources and the carrier frequency of the uplink resources may be indicated in the system information transmitted on the downlink resources.

“Configured cells” are those cells of which the UE is aware and is allowed by a base station to transmit or receive information. “Configured cell(s)” may be serving cell(s). The UE may receive system information and perform the required measurements on configured cells. “Configured cell(s)” for a radio connection may consist of a primary cell and/or no, one, or more secondary cell(s). “Activated cells” are those configured cells on which the UE is transmitting and receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

The base stations may be connected by the NG interface to the 5G-core network (5G-CN). 5G-CN may be called as to NextGen core (NGC), or 5G core (5GC). The base stations may also be connected by the S1 interface to the evolved packet core (EPC). For instance, the base stations may be connected to a NextGen (NG) mobility management function by the NG-2 interface and to the NG core User Plane (UP) functions by the NG-3 interface. The NG interface supports a many-to-many relation between NG mobility management functions, NG core UP functions and the base stations. The NG-2 interface is the NG interface for the control plane and the NG-3 interface is the NG interface for the user plane. For instance, for EPC connection, the base stations may be connected to a mobility management entity (MME) by the S1-MME interface and to the serving gateway (S-GW) by the S1-U interface. The S1 interface supports a many-to-many relation between MMEs, serving gateways and the base stations. The S1-MME interface is the S1 interface for the control plane and the S1-U interface is the S1 interface for the user plane. The Uu interface is a radio interface between the UE and the base station for the radio protocol.

The radio protocol architecture may include the user plane and the control plane. The user plane protocol stack may include packet data convergence protocol (PDCP), radio link control (RLC), medium access control (MAC) and physical (PHY) layers. A DRB (Data Radio Bearer) is a radio bearer that carries user data (as opposed to control plane signaling). For example, a DRB may be mapped to the user plane protocol stack. The PDCP, RLC, MAC and PHY sublayers (terminated at the base station 460a on the network) may perform functions (e.g., header compression, ciphering, scheduling, ARQ and HARQ) for the user plane. PDCP entities are located in the PDCP sublayer. RLC entities may be located in the RLC sublayer. MAC entities may be located in the MAC sublayer. The PHY entities may be located in the PHY sublayer.

The control plane may include a control plane protocol stack. The PDCP sublayer (terminated in base station on the network side) may perform functions (e.g., ciphering and integrity protection) for the control plane. The RLC and MAC sublayers (terminated in base station on the network side) may perform the same functions as for the user plane. The Radio Resource Control (RRC) (terminated in base station on the network side) may perform the following functions. The RRC may perform broadcast functions, paging, RRC connection management, radio bearer (RB) control, mobility functions, UE measurement reporting and control. The Non-Access Stratum (NAS) control protocol (terminated in MME on the network side) may perform, among other things, evolved packet system (EPS) bearer management, authentication, evolved packet system connection management (ECM)-IDLE mobility handling, paging origination in ECM-IDLE and security control.

Signaling Radio Bearers (SRBs) are Radio Bearers (RB) that may be used only for the transmission of RRC and NAS messages. Three SRBs may be defined. SRB0 may be used for RRC messages using the common control channel (CCCH) logical channel. SRB1 may be used for RRC messages (which may include a piggybacked NAS message) as well as for NAS messages prior to the establishment of SRB2, all using the dedicated control channel (DCCH) logical channel. SRB2 may be used for RRC messages which include logged measurement information as well as for NAS messages, all using the DCCH logical channel. SRB2 has a lower-priority than SRB1 and may be configured by a network (e.g., base station) after security activation. A broadcast control channel (BCCH) logical channel may be used for broadcasting system information. Some of BCCH logical channel may convey system information which may be sent from the network to the UE via BCH (Broadcast Channel) transport channel. BCH may be sent on a physical broadcast channel (PBCH). Some of BCCH logical channel may convey system information which may be sent from the network to the UE via DL-SCH (Downlink Shared Channel) transport channel. Paging may be provided by using paging control channel (PCCH) logical channel.

System information may be divided into the MasterInformationBlock (MIB) and a number of SystemInformationBlocks (SIBs).

The UE may receive one or more RRC messages from the base station to obtain RRC configurations or parameters. The RRC layer of the UE may configure RRC layer and/or lower layers (e.g., PHY layer, MAC layer, RLC layer, PDCP layer) of the UE according to the RRC configurations or parameters which may be configured by the RRC messages, broadcasted system information, and so on. The base station may transmit one or more RRC messages to the UE to cause the UE to configure RRC layer and/or lower layers of the UE according to the RRC configurations or parameters which may be configured by the RRC messages, broadcasted system information, and so on.

The size of various fields in the time domain is expressed in time units T_{c}=1/(Δfₘₐₓ×N_{f}) where Δfₘₐₓ=480×10³ Hz and N_{f}=4096. The constant κ=Tₛ/T_{c}=64 where Tₛ=1/(Δf_{ref}·N_{f,ref}), Δf_{ref}=15·10³ Hz and N_{f,ref}=2048.

Multiple OFDM numerologies are supported as given by Table 4.2-1 of [TS 38.211] where μ and the cyclic prefix for a bandwidth part are obtained from the higher-layer parameter subcarrierSpacing and cyclicPrefix, respectively.

The size of various fields in the time domain may be expressed as a number of time units T_{c}=1/(15000×2048) seconds. Downlink and uplink transmissions are organized into frames with T_{f}=(ΔfₘₐₓN_{f}/100)·T_{c}=10 ms duration, each consisting of ten subframes of T_{sf}=(ΔfₘₐₓN_{f}/1000)·T_{c}=1 ms duration. The number of consecutive OFDM symbols per subframe is

$${N}_{s y m b}^{subframe , μ} = {N}_{s y m b}^{slot} {N}_{slot}^{subframe , μ} .$$

Each frame is divided into two equally-sized half-frames of five subframes each with half-frame 0 consisting of subframes 0-4 and half-frame 1 consisting of subframes 5-9.

For subcarrier spacing (SCS) configuration μ, slots are numbered

$${n}_{s}^{μ} ∈ \{ 0 , … , {N}_{s l o t}^{s u b f r a m e , μ} - 1 \}$$

in increasing order within a subframe and

$${n}_{s , f}^{μ} ∈ \{ 0 , … , {N}_{slot}^{frame , μ} - 1 \}$$

in increasing order within a frame.

$${N}_{slot}^{s ubframe , μ}$$

is the number of slots per subframe for subcarrier spacing configuration μ. There are

$${N}_{s y m b}^{s l o t}$$

consecutive OFDM symbols in a slot where

$${N}_{s y m b}^{slot}$$

depends on the cyclic prefix as given by Tables 4.3.2-1 and 4.3.2-2 of [TS 38.211]. The start of slot

$${n}_{s}^{μ}$$

in a subframe is aligned in time with the start of OFDM symbol

$${n}_{s}^{μ} {N}_{symb}^{slot}$$

in the same subframe. Subcarrier spacing refers to a spacing (or frequency bandwidth) between two consecutive subcarriers in the frequency domain. For example, the subcarrier spacing can be set to 15 kHz (i.e. μ=0), 30 kHz (i.e. μ=1), 60 kHz (i.e. μ=2), 120 kHz (i.e. μ=3), or 240 kHz (i.e. μ=4). A resource block is defined as a number of consecutive subcarriers (e.g. 12) in the frequency domain. For a carrier with different frequency, the applicable subcarrier may be different. For example, for a carrier in a frequency rang 1, a subcarrier spacing only among a set of {15 kHz, 30 kHz, 60 kHz} is applicable. For a carrier in a frequency rang 2, a subcarrier spacing only among a set of {60 kHz, 120 kHz, 240 kHz} is applicable. The base station may not configure an inapplicable subcarrier spacing for a carrier.

OFDM symbols in a slot can be classified as ‘downlink’, ‘flexible’, or ‘uplink’. Signaling of slot formats is described in subclause 11.1 of [TS 38.213].

In a slot in a downlink frame, the UE may assume that downlink transmissions only occur in ‘downlink’ or ‘flexible’ symbols. In a slot in an uplink frame, the UE may only transmit in ‘uplink’ or ‘flexible’ symbols.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

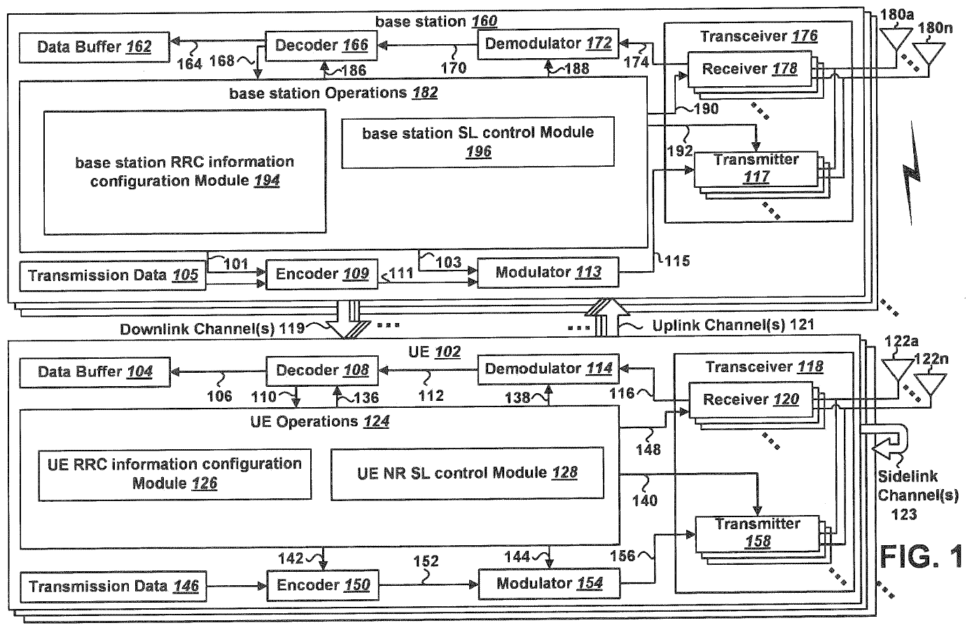

FIG. 1 is a block diagram illustrating one configuration of one or more base stations 160 (e.g., eNB, gNB) and one or more user equipments (UEs) 102 in which systems and methods for determination of sidelink CSI reporting for sidelink operation on FR2 licensed spectrum may be implemented. The one or more UEs 102 may communicate with one or more base stations 160 using one or more antennas 122a-n. For example, a UE 102 transmits electromagnetic signals to the base station 160 and receives electromagnetic signals from the base station 160 using the one or more antennas 122a-n. The base station 160 communicates with the UE 102 using one or more antennas 180a-n. Additionally, one or more UEs 102 may communicate with one or more UEs 102 using one or more antennas 122a-n. For example, a UE 102 transmits electromagnetic signals to another UE(s) 102 and receives electromagnetic signals from another UE(s) 102 using the one or more antennas 122a-n. That is, one or more UEs communicate with each other via sidelink communication.

The UEs 102 may directly communicate with each other by using the sidelink communication. For illustration, UE(s) 102 capable of sidelink communication include a UE 1A, a UE 1B and a UE 1C. The UE 1A may be located within the coverage of the base station 160. The UE 1B and the UE 1C may be located outside the coverage of the base station 160. The UE 1A and the base station 160 may communicate with each other via downlink and uplink communication. In addition, the UE 1A and the UE 1B may directly communicate with each other via sidelink communication. In addition, the UE 1B and the UE 1C may directly communicate with each other via sidelink communication.

It should be noted that in some configurations, one or more of the UEs 102 described herein may be implemented in a single device. For example, multiple UEs 102 may be combined into a single device in some implementations. Additionally or alternatively, in some configurations, one or more of the base stations 160 described herein may be implemented in a single device. For example, multiple base stations 160 may be combined into a single device in some implementations. In the context of FIG. 1, for instance, a single device may include one or more UEs 102 in accordance with the systems and methods described herein. Additionally or alternatively, one or more base stations 160 in accordance with the systems and methods described herein may be implemented as a single device or multiple devices.

The UE 102 and the base station 160 may use one or more channels 119, 121 to communicate with each other. For example, a UE 102 may transmit information or data to the base station 160 using one or more uplink (UL) channels 121 and signals. Examples of uplink channels 121 include a physical uplink control channel (PUCCH) and a physical uplink shared channel (PUSCH), etc. Examples of uplink signals include a demodulation reference signal (DMRS) and a sounding reference signal (SRS), etc. The one or more base stations 160 may also transmit information or data to the one or more UEs 102 using one or more downlink (DL) channels 119 and signals, for instance. Examples of downlink channels 119 include a PDCCH, a PDSCH, etc. A PDCCH can be used to schedule DL transmissions on PDSCH and UL transmissions on PUSCH, where the Downlink Control Information (DCI) on PDCCH includes downlink assignment and uplink scheduling grants. A PDCCH can be also used for scheduling of sidelink transmissions on PSCCH and PSSCH in one cell, where the Downlink Control Information (DCI) on PDCCH includes sidelink scheduling grants. The PDCCH is used for transmitting Downlink Control Information (DCI) in a case of downlink radio communication (radio communication from the base station to the UE). Here, one or more DCIs (may be referred to as DCI formats) are defined for transmission of downlink control information. Information bits are mapped to one or more fields defined in a DCI format. Examples of downlink signals include a primary synchronization signal (PSS), a secondary synchronization signal (SSS), a cell-specific reference signal (CRS), a non-zero power channel state information reference signal (NZP CSI-RS), and a zero power channel state information reference signal (ZP CSI-RS), etc. Other kinds of channels or signals may be used.

For the UE(s) 102 capable of sidelink communication, the UEs 102 may use one or more sidelink channels 123 to communicate with each other. For example, a UE 102 may transmit information or data to another UE 102 using one or more sidelink (SL) channels 123 and signals. Examples of sidelink channels 123 include a physical sidelink control channel (PSCCH), a physical sidelink shared channel (PSSCH), a physical sidelink feedback channel (PSFCH), and a physical sidelink broadcast channel (PSBCH). Examples of sidelink signals include a demodulation reference signal (DMRS), a phase-tracking reference signal (PT-RS), a channel-state information reference signal (CSI-RS), a sidelink primary synchronization signal (S-PSS), and a sidelink secondary synchronization signal (S-SSS).

Each of the one or more UEs 102 may include one or more transceivers 118, one or more demodulators 114, one or more decoders 108, one or more encoders 150, one or more modulators 154, one or more data buffers 104 and one or more UE operations modules 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals (e.g., downlink channels, downlink signals, sidelink channels, sidelink signals) from the base station 160 or from another UE 102 using one or more antennas 122a-n. For example, the receiver 120 may receive and downconvert signals to produce one or more received signals 116. The one or more received signals 116 may be provided to a demodulator 114. The one or more transmitters 158 may transmit signals (e.g., uplink channels, uplink signals, sidelink channels, sidelink signals) to the base station 160 or to another UE 102 using one or more antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce one or more decoded signals 106, 110. For example, a first UE-decoded signal 106 may comprise received payload data, which may be stored in a data buffer 104. A second UE-decoded signal 110 may comprise overhead data and/or control data. For example, the second UE-decoded signal 110 may provide data that may be used by the UE operations module 124 to perform one or more operations.

As used herein, the term “module” may mean that a particular element or component may be implemented in hardware, software or a combination of hardware and software. However, it should be noted that any element denoted as a “module” herein may alternatively be implemented in hardware. For example, the UE operations module 124 may be implemented in hardware, software or a combination of both.

In general, the UE operations module 124 may enable the UE 102 to communicate with the one or more base stations 160. For a UE capable of sidelink communication, the UE operations module 124 may enable the UE 102 to communicate with the one or more other UE. The UE operations module 124 may include a UE RRC information configuration module 126. For a UE capable of sidelink communication, the UE operations module 124 may include a UE sidelink (SL) control module 128. In some implementations, the UE operations module 124 may include physical (PHY) entities, Medium Access Control (MAC) entities, Radio Link Control (RLC) entities, packet data convergence protocol (PDCP) entities, and a Radio Resource Control (RRC) entity. For example, the UE RRC information configuration module 126 may process RRC parameter for random access configurations, initial UL BWP configuration, maximum bandwidth the UE can support, and cell specific PUCCH resource configuration(s).

For a UE capable of sidelink transmission, the UE RRC information configuration module 126 may process parameters included in the (pre-)configuration(s) related to sidelink communications. The UE RRC information configuration module 126 may process parameters transmitted from other UE(s), for example, relating to sidelink CSI-RS. The UE RRC information configuration module 126 may include a memory unit to store the (pre-)configuration(s) related to sidelink communications. For example, the UE RRC information configuration module 126 may, based on the parameters, determine a SL BWP, one or more resource pools within the SL BWP in frequency domain and time domain for SL communications. The UE SL control module 128 may determine the frequency resources, the time resources, the code resources, and/or numerologies for transmission or reception of the PSCCH, the PSSCH, S-SS/PSBCH and/or the PSFCH. The frequency resources for transmission or reception of the PSCCH, the PSSCH and the PSFCH include information related to assigned interlace(s) and RB set(s).

The UE SL control module 128 may determine to send a sidelink CSI report to other UE(s) that request the sidelink CSI report. The UE SL control module 128 may determine the reporting contents of the sidelink CSI report and may determine, based on the reporting contents of the sidelink CSI report, to select a first sidelink CSI reporting method or a second sidelink CSI reporting method.

The UE RRC information configuration module 126 may provide information related to SL BWP configuration and resource pool configuration to the UE SL control module 128, The UE SL control module 128 may set the SL BWP configuration and the resource pool configuration.

The UE operations module 124 may provide information 148 to the one or more receivers 120. For example, the UE operations module 124 may inform the receiver(s) 120 when or when not to receive transmissions based on the Radio Resource Control (RRC) message (e.g., broadcasted system information, RRC reconfiguration message), MAC control element, SCI (Sidelink Control Information) and/or the DCI (Downlink Control Information). The UE operations module 124 may provide information 148, including the PDCCH monitoring occasions, DCI format size, PSCCH monitoring occasions and SCI format size, to the one or more receivers 120. The UE operation module 124 may inform the receiver(s) 120 when or where to receive/monitor the PDCCH candidate for DCI formats and/or the PSCCH candidate for SCI formats.

The UE operations module 124 may provide information 138 to the demodulator 114. For example, the UE operations module 124 may inform the demodulator 114 of a modulation pattern anticipated for transmissions from the base station 160.

The UE operations module 124 may provide information 136 to the decoder 108. For example, the UE operations module 124 may inform the decoder 108 of an anticipated encoding for transmissions from the base station 160. For example, the UE operations module 124 may inform the decoder 108 of an anticipated PDCCH candidate encoding with which DCI size for transmissions from the base station 160. The UE operations module 124 may inform the decoder 108 of an anticipated PSCCH candidate encoding with which SCI size for transmissions from another UE 102.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142.

The encoder 150 may encode transmission data 146 and/or other information 142 provided by the UE operations module 124. For example, encoding the data 146 and/or other information 142 may involve error detection and/or correction coding, mapping data to space, time and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the base station 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the base station 160 or another UE 102. The one or more transmitters 158 may upconvert and transmit the modulated signal(s) 156 to one or more base stations 160 or another one or more UEs 102.

The base station 160 may include one or more transceivers 176, one or more demodulators 172, one or more decoders 166, one or more encoders 109, one or more modulators 113, one or more data buffers 162 and one or more base station operations modules 182. For example, one or more reception and/or transmission paths may be implemented in a base station 160. For convenience, only a single transceiver 176, decoder 166, demodulator 172, encoder 109 and modulator 113 are illustrated in the base station 160, though multiple parallel elements (e.g., transceivers 176, decoders 166, demodulators 172, encoders 109 and modulators 113) may be implemented.

The transceiver 176 may include one or more receivers 178 and one or more transmitters 117. The one or more receivers 178 may receive signals (e.g., uplink channels, uplink signals) from the UE 102 using one or more antennas 180a-n. For example, the receiver 178 may receive and downconvert signals to produce one or more received signals 174. The one or more received signals 174 may be provided to a demodulator 172. The one or more transmitters 117 may transmit signals (e.g., downlink channels, downlink signals) to the UE 102 using one or more antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The base station 160 may use the decoder 166 to decode signals. The decoder 166 may produce one or more decoded signals 164, 168. For example, a first base station-decoded signal 164 may comprise received payload data, which may be stored in a data buffer 162. A second base station-decoded signal 168 may comprise overhead data and/or control data. For example, the second base station-decoded signal 168 may provide data (e.g., PUSCH transmission data) that may be used by the base station operations module 182 to perform one or more operations.

In general, the base station operations module 182 may enable the base station 160 to communicate with the one or more UEs 102. For a base station capable of sidelink communication, the UE operations module 124 may enable the base station 160 to communicate with the one or more UEs 102 capable of sidelink communication. The base station operations module 182 may include a base station RRC information configuration module 194. For a base station capable of sidelink communication, the base station operations module 182 may include a base station sidelink (SL) control module 196 (or a base station SL processing module 196). The base station operations module 182 may include PHY entities, MAC entities, RLC entities, PDCP entities, and an RRC entity.

For a base station capable of sidelink transmission, the base station SL control module 196 may determine, for respective UE, the time and frequency resource for scheduling PSCCH and PSSCH and input the information to the base station RRC information configuration module 194. The base station SL control module 196 may generate a DCI format 3_0 to indicate frequency and time resources of PSSCH to a UE 102. The base station SL control module 196 may generate a DCI format 3_0 to indicate frequency and time resources of PSSCH to a UE 102.

The base station operations module 182 may provide the benefit of performing PDCCH candidate search and monitoring efficiently. The base station operations module 182 may provide information 190 to the one or more receivers 178. For example, the base station operations module 182 may inform the receiver(s) 178 when or when not to receive transmissions based on the RRC message (e.g., broadcasted system information, RRC reconfiguration message), MAC control element, and/or the DCI (Downlink Control Information).

The base station operations module 182 may provide information 188 to the demodulator 172. For example, the base station operations module 182 may inform the demodulator 172 of a modulation pattern anticipated for transmissions from the UE(s) 102.

The base station operations module 182 may provide information 186 to the decoder 166. For example, the base station operations module 182 may inform the decoder 166 of an anticipated encoding for transmissions from the UE(s) 102.

The base station operations module 182 may provide information 101 to the encoder 109. The information 101 may include data to be encoded and/or instructions for encoding. For example, the base station operations module 182 may instruct the encoder 109 to encode transmission data 105 and/or other information 101.

In general, the base station operations module 182 may enable the base station 160 to communicate with one or more network nodes (e.g., a NG mobility management function, a NG core UP functions, a mobility management entity (MME), serving gateway (S-GW), gNBs). The base station operations module 182 may also generate a RRC reconfiguration message to be signaled to the UE 102.

The encoder 109 may encode transmission data 105 and/or other information 101 provided by the base station operations module 182. For example, encoding the data 105 and/or other information 101 may involve error detection and/or correction coding, mapping data to space, time and/or frequency resources for transmission, multiplexing, etc. The encoder 109 may provide encoded data 111 to the modulator 113. The transmission data 105 may include network data to be relayed to the UE 102.

The base station operations module 182 may provide information 103 to the modulator 113. This information 103 may include instructions for the modulator 113. For example, the base station operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The base station operations module 182 may provide information 192 to the one or more transmitters 117. This information 192 may include instructions for the one or more transmitters 117. For example, the base station operations module 182 may instruct the one or more transmitters 117 when to (or when not to) transmit a signal to the UE(s) 102. The base station operations module 182 may provide information 192, including the PDCCH monitoring occasions and DCI format size, to the one or more transmitters 117. The base station operation module 182 may inform the transmitter(s) 117 when or where to transmit the PDCCH candidate for DCI formats with which DCI size. The one or more transmitters 117 may upconvert and transmit the modulated signal(s) 115 to one or more UEs 102.

It should be noted that one or more of the elements or parts thereof included in the base station(s) 160 and UE(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

A base station may generate a RRC message including the one or more RRC parameters, and may transmit the RRC message to a UE. A UE may receive, from a base station, a RRC message including one or more RRC parameters. The term ‘RRC parameter(s)’ in the present disclosure may be alternatively referred to as ‘RRC information element(s)’. A RRC parameter may further include one or more RRC parameter(s). In the present disclosure, a RRC message may include system information, a RRC message may include one or more RRC parameters. A RRC message may be sent on a broadcast control channel (BCCH) logical channel, a common control channel (CCCH) logical channel or a dedicated control channel (DCCH) logical channel.

In the present disclosure, a description ‘a base station may configure a UE to’ may also imply/refer to ‘a base station may transmit, to a UE, an RRC message including one or more RRC parameters’. Additionally or alternatively, ‘RRC parameter configure a UE to’ may also refer to ‘a base station may transmit, to a UE, an RRC message including one or more RRC parameters’. Additionally or alternatively, ‘a UE is configured to’ may also refer to ‘a UE may receive, from a base station, an RRC message including one or more RRC parameters’.

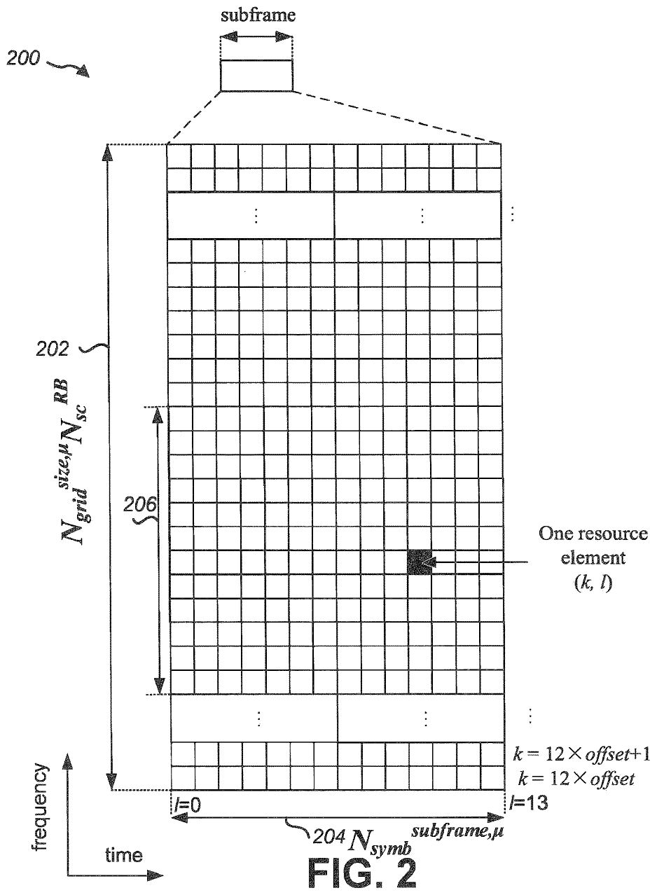

FIG. 2 is a diagram illustrating one example of a resource grid 200.

For each numerology (i.e., for each SCS u) and carrier, a resource grid of

$${N}_{grid , x}^{size , μ} {N}_{s c}^{R B}$$

subcarriers and N_{symb}^{subframe,μ} OFDM symbols is defined, starting at common resource block N_{grid}^{start,μ} indicated by higher layer signaling. There is one set of resource grids per transmission direction (uplink or downlink) with the subscript x set to DL and UL for downlink and uplink, respectively. There is one resource grid for a given antenna port p, subcarrier spacing configuration μ, and the transmission direction (downlink or uplink). When there is no risk for confusion, the subscript x may be dropped.

In the FIG. 2, the resource gird 200 includes the

$${N}_{grid , x}^{size , μ} {N}_{s c}^{R B}$$

(202) subcarriers in the frequency domain and includes N_{symb}^{subframe,μ} (204) symbols in the time domain. In the FIG. 2, as an example for illustration, the subcarrier spacing configuration μ is set to 0. That is, in the FIG. 2, the number of consecutive OFDM symbols N_{symb}^{subframe,μ} (204) per subframe is equal to 14.

The carrier bandwidth N_{grid}^{size,μ} (N_{grid,x}^{size,μ}) for subcarrier spacing configuration μ is given by the higher-layer (RRC) parameter carrierBandwidth in the SCS-SpecificCarrier IE. The starting position N_{grid}^{start,μ} for subcarrier spacing configuration μ is given by the higher-layer parameter offsetToCarrier in the SCS-SpecificCarrier IE. The frequency location of a subcarrier refers to the center frequency of that subcarrier.

In the FIG. 2, for example, a value of offset is provided by the higher-layer parameter offsetToCarrier. That is, k=12×offset is the lowest usable subcarrier on this carrier.

Each element in the resource grid for antenna port p and subcarrier spacing configuration μ is called a resource element and is uniquely identified by (k, l)_{p,u} where k is the index in the frequency domain and l refers to the symbols position in the time domain relative to same reference point. The resource element consists of one subcarrier during one OFDM symbol.

A resource block is defined as N_{sc}^{RB}=12 consecutive subcarriers in the frequency domain. As shown in the FIG. 2, a resource block 206 includes 12 consecutive subcarriers in the frequency domain. Resource block can be classified as common resource block (CRB) and physical resource block (PRB).

Common resource blocks are numbered from 0 and upwards in the frequency domain for subcarrier spacing configuration μ. The center of subcarrier 0 of common resource block with index 0 (i.e. CRB0) for subcarrier spacing configuration μ coincides with point A. The relation between the common resource block number

$${n}_{C R B}^{μ}$$

in the frequency domain and resource element (k, l) for subcarrier spacing configuration μ is given by Formula (1) n_{CRB}^{μ}=floor(k/N_{sc}^{RB}) where k is defined relative to the point A such that k=0 corresponds to the subcarrier centered around the point A. The function floor(A) hereinafter is floor operation to output a maximum integer not larger than the A.

Point A refers to as a common reference point. Point A coincides with subcarrier 0 (i.e., k=0) of a CRB 0 for all subcarrier spacing. Point A can be obtained from a RRC parameter offsetToPointA or a RRC parameter absoluteFrequencyPointA. The RRC parameter offsetToPointA is used for a PCell downlink and represents the frequency offset between point A and the lowest subcarrier of the lowest resource block, which has the subcarrier spacing provided by a higher-layer parameter subCarrierSpacingCommon and overlaps with the SS/PBCH block used by the UE for initial cell selection, expressed in units of resource blocks assuming 15 kHz subcarrier spacing for frequency range (FR) 1 and 60 kHz subcarrier spacing for frequency range (FR2). FR1 corresponds to a frequency range between 410 MHz and 7125 MHz. FR2 corresponds to a frequency range between 24250 MHz and 52600 MHz. The RRC parameter absoluteFrequencyPointA is used for all cased other than the PCell case and represents the frequency-location of point A expressed as in ARFCN. The frequency location of point A can be the lowest subcarrier of the carrier bandwidth (or the actual carrier). Additionally, point A may be located outside the carrier bandwidth (or the actual carrier).

As above mentioned, the information element (IE) SCS-SpecificCarrier provides parameters determining the location and width of the carrier bandwidth or the actual carrier. That is, a carrier (or a carrier bandwidth, or an actual carrier) is determined (identified, or defined) at least by a RRC parameter offsetToCarrier, a RRC parameter subcarrierSpacing, and a RRC parameter carrierBandwidth in the SCS-SpecificCarrier IE.

The subcarrierSpacing indicates (or defines) a subcarrier spacing of the carrier. The offsetToCarrier indicates an offset in frequency domain between point A and a lowest usable subcarrier on this carrier in number of resource blocks (e.g. CRBs) using the subcarrier spacing defined for the carrier. The carrierBandwidth indicates width of this carrier in number of resource blocks (e.g. CRBs or PRBs) using the subcarrier spacing defined for the carrier. A carrier includes at most 275 resource blocks.

Physical resource blocks for subcarrier spacing configuration μ are defined within a bandwidth part and numbered form 0 to N_{BWP,i}^{size,μ} where i is the number of the bandwidth part. The relation between the physical resource block n_{PRB}^{μ} in bandwidth part (BWP) i and the common resource block n_{CRB}^{μ} is given by Formula (2) n_{CRB}^{μ}=n_{PRB}^{μ}+N_{BWP,i}^{start,μ} where N_{BWP,i}^{start,μ} is the common resource block where bandwidth part i starts relative to common resource block 0 (CRB0). When there is no risk for confusion the index μ may be dropped.

A BWP is a subset of contiguous common resource block for a given subcarrier spacing configuration μ on a given carrier. To be specific, a BWP can be identified (or defined) at least by a subcarrier spacing u indicated by the RRC parameter subcarrierSpacing, a cyclic prefix determined by the RRC parameter cyclicPrefix, a frequency domain location, a bandwidth, an BWP index indicated by bwp-Id and so on. The locationAndBandwidth can be used to indicate the frequency domain location and bandwidth of a BWP. The value indicated by the locationAndBandwidth is interpreted as resource indicator value (RIV) corresponding to an offset (a starting resource block) RBₛₜₐᵣₜ and a length L_{RB} in terms of contiguously resource blocks. The offset RBₛₜₐᵣₜ is a number of CRBs between the lowest CRB of the carrier and the lowest CRB of the BWP. The N_{BWP,i}^{start,μ} is given as Formula (3) N_{BWP,i}^{start,μ}=O_{carrier}+RBₛₜₐᵣₜ. The value of O_{carrier} is provided by offsetTocarrier for the corresponding subcarrier spacing configuration μ.

A UE 102 configured to operate in BWPs of a serving cell, is configured by higher layers for the serving cell a set of at most four BWPs in the downlink for reception. At a given time, a single downlink BWP is active. The bases station 160 may not transmit, to the UE 102, PDSCH and/or PDCCH outside the active downlink BWP. A UE 102 configured to operate in BWPs of a serving cell, is configured by higher layers for the serving cell a set of at most four BWPs for transmission. At a given time, a single uplink BWP is active. The UE 102 may not transmit, to the base station 160, PUSCH or PUCCH outside the active BWP. The specific signaling (higher layers signaling) for BWP configurations are described later.

A UE 102, configured to operate in a SL BWP, is configured or preconfigured by higher layers for the serving cell or by a pre-configuration a SL BWP for sidelink reception and/or transmission. At a given time, a single SL BWP is active. The UE 102 may not transmit, to another UE 102, sidelink channel (PSCCH, PSCCH, and/or PSFCH) outside the active SL BWP.

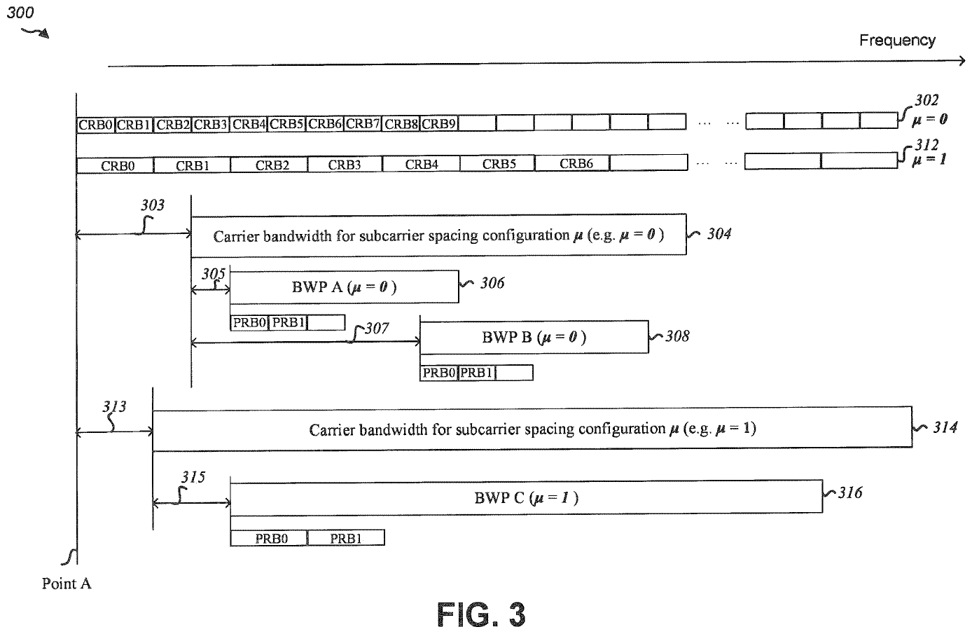

FIG. 3 is a diagram illustrating one example 300 of common resource block grid, carrier configuration and BWP configuration by a UE 102 and a base station 160.

Point A 301 is a lowest subcarrier of a CRB0 for all subcarrier spacing configurations. The CRB grid 302 and the CRB grid 312 are corresponding to two different subcarrier spacing configurations. The CRB grid 302 is for subcarrier spacing configuration μ=0 (i.e. the subcarrier spacing with 15 kHz). The CRB grid 312 is for subcarrier spacing configuration μ=1 (i.e., the subcarrier spacing with 30 kHz).

One or more carriers are determined by respective SCS-SpecificCarrier IEs, respectively. In the FIG. 3, the carrier 304 uses the subcarrier spacing configuration μ=0. And the carrier 314 uses the subcarrier spacing configuration μ=1. The starting position N_{grid}^{start,μ} of the carrier 304 is given based on the value of an offset 303 (i.e. O_{carrier}) indicated by an offsetToCarrier in an SCS-SpecificCarrier IE. As shown in the FIG. 3, for example, the offsetToCarrier indicates the value of the offset 303 as O_{carrier}=3. That is, the starting position N_{grid}^{start,μ} of the carrier 304 corresponds to the CRB3 of the CRB grid 302 for subcarrier spacing configuration μ=0. In the meantime, the starting position N_{grid}^{start,μ} of the carrier 314 is given based on the value of an offset 313 (i.e. O_{carrier}) indicated by an offsetToCarrier in another SCS-SpecificCarrier IE. For example, the offsetToCarrier indicates the value of the offset 313 as O_{carrier}=1. That is, the starting position N_{grid}^{start,μ} of the carrier 314 corresponds to the CRB1 of the CRB grid 312 for subcarrier spacing configuration μ=1. A carrier using different subcarrier spacing configurations can occupy different frequency ranges.

As above-mentioned, a BWP is for a given subcarrier spacing configuration μ. One or more BWPs can be configured for a same subcarrier spacing configuration μ. For example, in the FIG. 3, the BWP 306 is identified at least by the μ=0, a frequency domain location, a bandwidth (L_{RB}), and an BWP index (index A). The first PRB (i.e. PRB0) of a BWP is determined at least by the subcarrier spacing of the BWP, an offset derived by the locationAndBandwidth and an offset indicated by the offsetToCarrier corresponding to the subcarrier spacing of the BWP. An offset 305 (RBₛₜₐᵣₜ) is derived as 1 by the locationAndBandwidth. According to the Formulas (2) and (3), the PRB0 of BWP 306 corresponds to CRB 4 of the CRB grid 302, and the PRB1 of BWP 306 corresponds to CRB 5 of the CRB grid 302, and so on.

Additionally, in the FIG. 3, the BWP 308 is identified at least by the μ=0, a frequency domain location, a bandwidth (L_{RB}), and an BWP index (index B). For example, an offset 307 (RBₛₜₐᵣₜ) is derived as 6 by the locationAndBandwidth. According to the Formulas (2) and (3), the PRB0 of BWP 308 corresponds to CRB 9 of the CRB grid 302, and the PRB1 of BWP 308 corresponds to CRB 10 of the CRB grid 302, and so on.

Additionally, in the FIG. 3, the BWP 316 is identified at least by the μ=1, a frequency domain location, a bandwidth (L_{RB}), and an BWP index (index C). For example, an offset 315 (RBₛₜₐᵣₜ) is derived as 1 by the locationAndBandwidth. According to the Formulas (2) and (3), the PRB0 of BWP 316 corresponds to CRB 2 of the CRB grid 312, and the PRB1 of BWP 316 corresponds to CRB 3 of the CRB grid 312, and so on.

In the present disclosure, a BWP illustrated in the FIG. 3 may refer to a DL BWP, a UL BWP, or a sidelink BWP.

As shown in the FIG. 3, a carrier with the defined subcarrier spacing locate in a corresponding CRB grid with the same subcarrier spacing. A BWP with the defined subcarrier spacing locate in a corresponding CRB grid with the same subcarrier spacing as well.

A base station may transmit a RRC message including one or more RRC parameters related to BWP configuration to a UE. A UE may receive the RRC message including one or more RRC parameters related to BWP configuration from a base station. For each cell, the base station may configure at least an initial DL BWP, one initial uplink bandwidth parts (initial UL BWP) and one sidelink BWP to the UE. Furthermore, the base station may configure additional UL and DL BWPs to the UE for a cell.

SIB1, which is a cell-specific system information block (SystemInformationBlock, SIB), may contain information relevant when evaluating if a UE is allowed to access a cell and define the scheduling of other system information. SIB1 may also contain radio resource configuration information that is common for all UEs and barring information applied to the unified access control. The RRC parameter ServingCellConfigCommon is used to configure cell specific parameters of a UE's serving cell. The RRC parameter ServingCellConfig is used to configure (add or modify) the UE with a serving cell, which may be the SpCell or an SCell of an MCS or SCG. The RRC parameter ServingCellConfig herein are mostly UE specific but partly also cell specific.

The base station may configure the UE with a RRC parameter BWP-Downlink and a RRC parameter BWP-Uplink. The RRC parameter BWP-Downlink can be used to configure an additional DL BWP. The RRC parameter BWP-Uplink can be used to configure an additional UL BWP. The base station may transmit the BWP-Downlink and the BWP-Uplink which may be included in RRC parameter ServingCellConfig to the UE.

The UE may be configured by the based station, at least one initial BWP and up to 4 additional BWP(s). One of the initial BWP and the configured additional BWP(s) may be activated as an active BWP. The UE may monitor DCI format, and/or receive PDSCH in the active DL BWP. The UE may not monitor DCI format, and/or receive PDSCH in a DL BWP other than the active DL BWP. The UE may transmit PUSCH and/or PUCCH in the active UL BWP. The UE may not transmit PUSCH and/or PUCCH in a BWP other than the active UL BWP.

As above-mentioned, a UE may monitor DCI format in the active DL BWP. To be more specific, a UE may monitor a set of PDCCH candidates in one or more CORESETs on the active DL BWP on each activated serving cell configured with PDCCH monitoring according to corresponding search space set where monitoring implies decoding each PDCCH candidate according to the monitored DCI formats.

A set of PDCCH candidates for a UE to monitor is defined in terms of PDCCH search space sets. A search space set can be a CSS set or a USS set. A UE may monitor a set of PDCCH candidates in one or more of the search space sets.

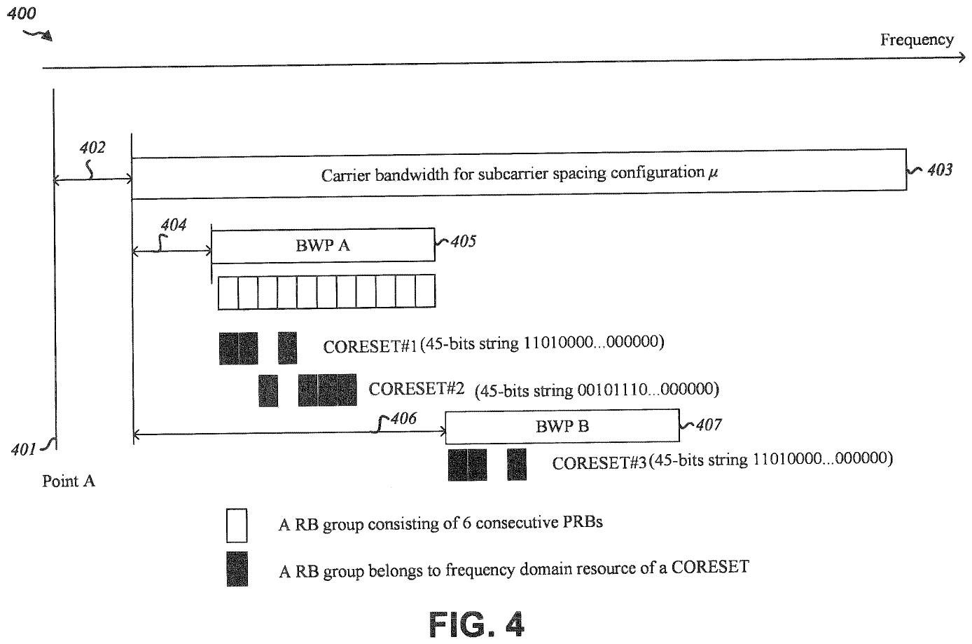

FIG. 4 is a diagram illustrating one 400 example of CORESET configuration in a BWP by a UE 102 and a base station 160.

FIG. 4 illustrates that a UE 102 is configured with three CORESETs for receiving PDCCH transmission in two BWPs. In the FIG. 4, 401 represent point A. 402 is an offset in frequency domain between point A 401 and a lowest usable subcarrier on the carrier 403 in number of CRBs, and the offset 402 is given by the offsetToCarrier in the SCS-SpecificCarrier IE. The BWP 405 with index A and the carrier 403 are for a same subcarrier spacing configuration μ. The offset 404 between the lowest CRB of the carrier and the lowest CRB of the BWP in number of RBs is given by the locationAndBandwidth included in the BWP configuration for BWP A. The BWP 407 with index B and the carrier 403 are for a same subcarrier spacing configuration μ. The offset 406 between the lowest CRB of the carrier and the lowest CRB of the BWP in number of RBs is given by the locationAndBandwidth included in the BWP configuration for BWP B.

For the BWP 405, two CORESETs are configured. As above-mentioned, a RRC parameter frequencyDomainResource in respective CORESET configuration indicates the frequency domain resource for respective CORESET. In the frequency domain, a CORESET is defined in multiples of RB groups and each RB group consists of 6 RBs. For example, in the FIG. 4, the RRC parameter frequencyDomainResource provides a bit string with a fixed size (e.g. 45 bits) as like ‘11010000 . . . 000000’ for CORESET #1. That is, the first RB group, the second RB group, and the fourth RB group belong to the frequency domain resource of the CORESET #1. Additionally, the RRC parameter frequencyDomainResource provides a bit string with a fixed size (e.g. 45 bits) as like ‘00101110 . . . 000000’ for CORESET #2. That is, the third RB group, the fifth RB group, the sixth RB group and the seventh RB group belong to the frequency domain resource of the CORESET #2.

For the BWP 407, one CORESET is configured. As above-mentioned, a RRC parameter frequencyDomainResource in the CORESET configuration indicates the frequency domain resource for the CORESET #3. In the frequency domain, a CORESET is defined in multiples of RB groups and each RB group consists of 6 RBs. For example, in the FIG. 4, the RRC parameter frequencyDomainResource provides a bit string with a fixed size (e.g. 45 bits) as like ‘11010000 . . . 000000’ for CORESET #3. That is, the first RB group, the second RB group, and the fourth RB group belong to the frequency domain resource of the CORESET #3. Although the bit string configured for CORESET #3 is same as that for CORESET #1, the first RB group of the BWP B is different from that of the BWP A in the carrier. Therefore, the frequency domain resource of the CORESET #3 in the carrier is different from that of the CORESET #1 as well.

Vehicle-to-everything (V2X) communication technologies have been developed by 3GPP for the automotive industry. V2X refers to a communication technology through which a vehicle exchanges information with another vehicle, a pedestrian, an object having an infrastructure, and so on. The V2X is divided into 4 types, such as vehicle-to-vehicle (V2V), vehicle-to-infrastructure (V2I), vehicle-to-network (V2N), and vehicle-to-pedestrian (V2P). Therefore, the V2X communication is different from the communication between the UEs and gNBs. The V2X communication enables the communication between the UEs, which is also called as sidelink. That is, sidelink communication supports UE-to-UE direct communication via a PC5 interface. In other words, sidelink communication is directly performed or communicated between one transmitting UE and one or more receiving UEs.

Sidelink communication consists of unicast, groupcast and broadcast. The unicast may refer to a communication between two UEs, i.e., one transmitting UE and one receiving UE. The groupcast and/or the broadcast may refer to a communication between one transmitting UE and multiple receiving UEs.

Currently NR Sidelink communication supports two sidelink resource allocation modes, mode 1 and mode 2. The difference between the sidelink resource allocation mode 1 and the sidelink resource allocation mode 2 lies in which determine the resource to be used for the sidelink communication.

In mode 1, the sidelink resource allocation is provided or determined by the base station and/or the network. That is, for mode 1, the base station may manage the resource allocation for the UEs. For example, a base station may allocate the resources for sidelink communication to an in-coverage UE. In sidelink resource allocation mode 1, dynamic grant, configured grant type 1 and configured grant type 2 are supported for PSSCH and PSCCH transmission. In sidelink resource allocation mode 1, for sidelink dynamic grant, the PSSCH transmission is scheduled by a DCI format 3_0. For sidelink configured grant type 1, the configured grant is provided (activated) or released (deactivated) by RRC signaling. For sidelink configured grant type 2, the configured grant is provided or released by PDCCH with the DCI format 3_0.

In mode 2, the sidelink resource allocation is determined by a TX UE itself. The UE may decide the sidelink transmission resources in a resource pool. The UE may carry out the resource allocation without involvement of the base station. These UEs may autonomously determine to select resources for sidelink communication based on a sensing-based procedure.

In mode 1, the DCI format 3_0 is used by the base station for scheduling of NR PSCCH and NR PSSCH in one cell. The base station may determine the scheduling information of NR PSCCH and NR PSSCH and provide the scheduling information to an in-coverage UE. The scheduling information may at least include a Resource pool index field, a time gap field, a HARQ process number field, a new data indicator field, a Lowest index of the subchannel allocation to the initial transmission field, SCI format 1-A fields, and so on. The Resource pool index field is used to indicate an index of a resource pool for which the sidelink transmission is scheduled and the SCI format 1-A fields here refer to the frequency resource assignment field and the time resource assignment field. That is, in mode 1, the base station may determine the time and frequency resource assignment for scheduling of sidelink transmission and then generate the corresponding fields of the scheduling information in the DCI format 3_0. A TX UE (an in-coverage UE) that received the DCI format 3_0 may transmit the PSCCH with SCI format 1-A and the PSSCH in the resource assigned by the base station based on the scheduling information in the DCI format 3_0. Moreover, the SCI format 1-A transmitted by the TX UE includes the frequency resource assignment field and the time resource assignment field which are as same as those included in the DCI format 3_0. A RX UE (an out-coverage UE and/or an in-coverage UE) that received the PSCCH with the SCI format 1-A can receive the PSSCH in the resource assigned by the base station.

In mode 2, a TX UE may autonomously determine to select resources for sidelink communication and generate the fields in SCI format 1-A to notify an RX UE of the time and frequency resource assignment. The RX UE that received the PSCCH with the SCI format 1-A can receive the PSSCH in the resource assigned by the TX UE.

Sidelink communication supports physical channels such as Physical Sidelink Control Channel (PSCCH), Physical Sidelink Shared Channel (PSSCH), Physical Sidelink Feedback Channel (PSFCH), and Physical Sidelink Broadcast Channel (PSBCH).

The PSCCH is used for transmitting/receiving sidelink control information (e.g., the 1^{st}-stage SCI). For example, the PSCCH indicates resource and other transmission parameters used by a UE for PSSCH reception. PSCCH transmission is associated with a DM-RS. For PSCCH, QPSK is supported.

The PSSCH is used for transmitting/receiving sidelink control information (e.g., the 2^{nd}-stage SCI), transport block(s) of data, and channel state information (CSI). The sidelink control information herein may include information, for example, for HARQ for HARQ procedures and CSI feedback triggers, etc. At least 6 OFDM symbols within a slot are used for PSSCH transmission. PSSCH transmission is associated with a DM-RS and may be associated with a PT-RS. For PSSCH, QPSK, 16QAM, 64QAM and 256QAM are supported.

PSFCH is used for carrying HARQ feedback over the sidelink from a UE which is an intended recipient of a PSSCH transmission to the UE which performed the PSSCH transmission. PSFCH sequence is transmitted in one PRB repeated over two OFDM symbols near the end of the sidelink resource in a slot.

The PSBCH is used for transmitting broadcast information. PSBCH occupies 9 and 7 symbols for normal and extended CP cases respectively, including the associated DM-RS.

Sidelink communication supports physical signals such as demodulation reference signal (DM-RS), phase-tracking reference signal (PT-RS), channel-state information reference signal (CSI-RS), sidelink synchronization signals.

The DMRS(s) are associated with PSCCH, PSSCH and/or PSBCH. A transmitting UE may transmit the DMRS within the associated sidelink physical channel. A receiving UE may use the DMRS to estimate and/or decode the associated sidelink physical channel.

The PT-RS is used to mitigate the effect of phase noise. A transmitting UE may transmit the PT-RS within the PSSCH transmission. The receiving UE may receive the PT-RS and use the PT-RS to mitigate the effect of phase noise.

The CSI-RS is used for measuring channel state information. A transmitting UE may transmit sidelink CSI-RS within a unicast PSSCH transmission. A receiving UE may measure the channel state information by using the CSI-RS and transmit a CSI report based on the measurement to the transmitting UE.

The Sidelink synchronization signal consists of sidelink primary and sidelink secondary synchronization signals (S-PSS, S-SSS), each occupying 2 symbols and 127 subcarriers. The sidelink synchronization signals are transmitted together with the PSBCH in a slot. Specifically, reception occasions of a PSBCH, S-PSS, and S-SSS are in consecutive symbols in a slot and form a S-SS/PSBCH block. For a SL-BWP, the S-SS/PSBCH block has a same SCS as the PSCCH, the PSSCH, and/or the PSFCH.

In various implementations of the present disclosure, a UE may be provided NR sidelink communication (pre-)configuration(s). For simplicity, (pre-)configuration(s) hereinafter refer to the NR sidelink communication (pre-)configuration(s). (Pre-)configuration(s) in the present disclosure may include configuration(s) received by system information (e.g., SIB 12) from a base station, configuration(s) received by dedicated RRC signaling (e.g., RRC configuration/parameters/message) from a base station, and/or configuration(s) preconfigured in the UE (i.e., pre-configuration). Regarding the pre-configuration, a memory unit of the UE may store the pre-configuration in advance.

In various examples or implementations of the present disclosure, (pre-)configuration(s) may include configuration(s) of one or more sidelink BWPs for sidelink communication. That is, a UE may receive the configuration(s) of the one or more BWPs included in system information, in dedicated RRC signaling, and/or in a pre-configuration. In the present disclosure, a UE may be provided by the (pre-)configuration(s) a BWP for sidelink transmissions.

In various examples or implementations of the present disclosure, a SL BWP configuration may include configuration(s) of one or more resource pools for sidelink communication. That is, the configuration(s) of the one or more resource pools (the configuration(s) related to the one or more resource pools) may be received in system information, received in dedicated RRC signaling, and/or preconfigured in a pre-configuration. According to the configuration(s), a resource pool may be indicated to be used either for sidelink communication reception or for sidelink communication transmission. Additionally or alternatively, a resource pool may be indicated to be used for both sidelink communication reception and sidelink communication transmission. Each resource pool is associated with either the sidelink resource allocation Mode 1 or the sidelink resource allocation Mode 2.

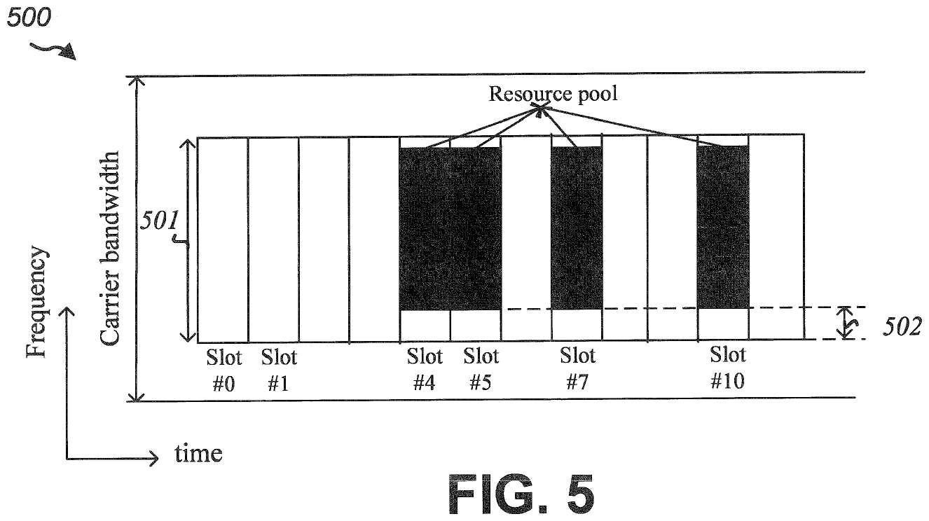

FIG. 5 is a diagram illustrating one example 500 of a SL BWP and a resource pool within the SL BWP.

A UE 102 is provided by a parameter SL-BWP-Config a BWP (a SL BWP) for sidelink transmission with numerology and resource grid. The determination of a SL BWP 501 is similar as how to determine a BWP specified in the FIG. 3.

In the FIG. 5, each block in the time domain represents a slot. One resource pool is configured within the SL BWP 501. The resource pool can be for transmission of PSSCH, PSCCH and/or PSFCH, and/or for reception of PSSCH, PSCCH and/or PSFCH. The first RB of the resource pool relative to the first RB of SL BWP, 502, may be indicated by a parameter included in the (pre-)configurations.

Not all the slots within the SL BWP may be assigned to a resource pool within the SL BWP. That is, not all the slots may belong to a resource pool. A slot assigned to a resource pool (or a slot belongs to a resource pool) can be also referred to a slot available for the resource pool. On the contrary, a slot not assigned to a resource pool (or a slot does not belong to a resource pool) can be also referred to a slot unavailable for the resource pool. Therefore, a resource pool may consist of a plurality (set) of non-contiguous slots in the time domain. In a SL BWP, different resource pools may be assigned with different sets of slots. The UE may determine the set of slots assigned to a resource pool according to the (pre-)configurations. A transmitting UE may transmit one or more physical SL channels or one or more SL signals in one or more resource pools within a SL BWP, while a receiving UE may receive one or more physical SL channels or one or more SL signals in one or more resource pools within a SL BWP.

In the FIG. 5, slot #0 refers to a first slot of a radio frame corresponding to SFN 0 of the serving cell or DFN 0. As illustrated in the FIG. 5, a set of slots with indexes #4, #5, #7 and #10 belong to the resource pool. The slots in the set for a resource pool are re-indexed such that the logical slot indexes are successive from 0 to T′ₘₐₓ−1 where the T′ₘₐₓ is the number of the slot in the set. For example, in the FIG. 5, the four slots in the set can be re-indexed as slots with logical slot indexes 0, 1, 2, and 3. The slots available for a resource pool may be provided or indicated by a parameter sl-TimeResource and may occur with a periodicity of 10240 ms.

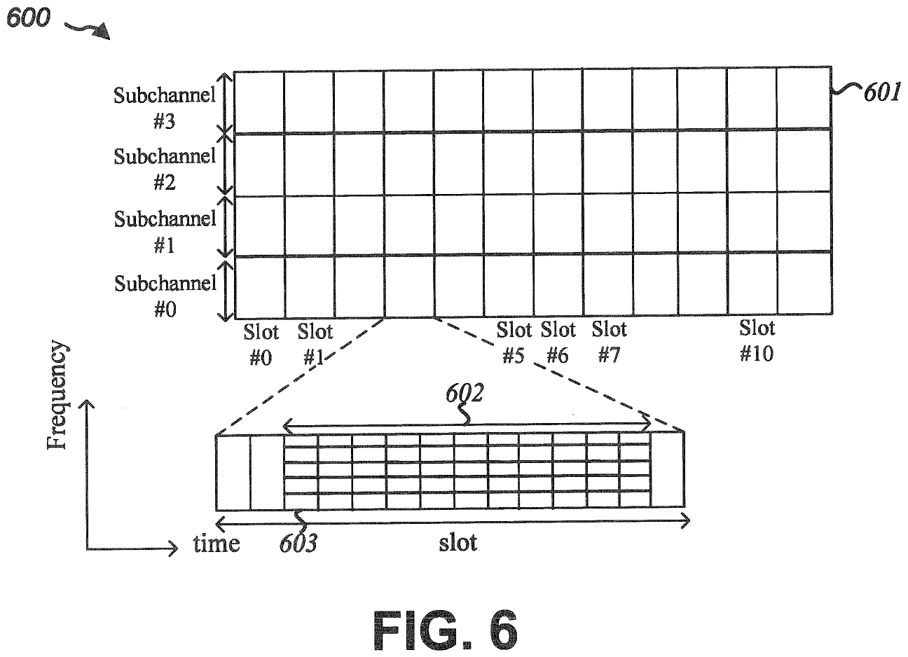

FIG. 6 is a diagram illustrating one example 600 of a resource pool configuration in time and frequency domain.

A resource pool within a SL BWP can be divided into one or multiple contiguous sub-channels in the frequency domain. That is, a resource pool within a SL BWP consists of one or multiple contiguous sub-channels in the frequency domain. The number of the one or multiple sub-channels is indicated by a parameter sl-NumSubchannel included in the configuration of the resource pool. Each sub-channel includes a number of contiguous RBs in the frequency domain. The number of contiguous RBs is indicated by a parameter sl-SubchannelSize included in the configuration of the resource pool. For illustration, the number of contiguous RBs indicated by the parameter sl-SubchannelSize can be denoted as K_{sub}.

In the FIG. 6, each block in the frequency domain represents a sub-channel of the resource pool 601. For example, in the FIG. 6, the parameter sl-NumSubchannel indicates that the number of one or multiple contiguous sub-channels is 4. That is, the resource pool 601 consists of 4 contiguous sub-channels in the frequency domain. The first RB of the first sub-channel of the resource pool 601 in the SL BWP may be indicated by a parameter sl-StartRB-Subchannel. The first sub-channel of a resource pool refers to a sub-channel with the lowest subchannel index in the resource pool. In the FIG. 6, the subchannel #0 is the first sub-channel of the resource pool 601, that is, the sub-channel with the lowest subchannel index 0. As shown in the FIG. 6, the subchannel #0 includes K_{sub} contiguous PRBs starting from the PRB indicated by the parameter sl-StartRB-Subchannel; the subchannel #1 includes K_{sub} contiguous PRBs starting from a PRB adjacent to the last RB of the subchannel #0; the subchannel #2 includes K_{sub} contiguous PRBs starting from a PRB adjacent to the last RB of the subchannel #1; subchannel #3 includes K_{sub} contiguous PRBs starting from a PRB adjacent to the last RB of the subchannel #2.

In the present disclosure, the determination of the sub-channel(s) for a resource pool are based on the parameters related to sub-channel as above-mention. And the determination of the sub-channel(s) can be applied to a resource pool regardless of whether the SCS of the resource pool is 15 kHz, 30 kHz, or 60 kHz.

In the frequency domain, the frequency domain resource allocation granularity is one sub-channel for a PSSCH transmission. That is, for PSSCH transmission, the frequency domain unit is a sub-channel. A PSSCH transmission may be performed in one or more contiguous sub-channels in the frequency domain.

In the time domain, each block in the time domain represents a slot in the set of slots assigned to the resource pool 601. The slot indexes in the FIG. 6 refer to the logical slot indexes. The OFDM symbols within a slot assigned for sidelink transmission are provided by parameters included in the (pre-)configuration.

For example, SL transmissions can start from a first symbol indicated by a parameter sl-StartSymbol and be within a number of consecutive symbols indicated by a parameter sl-LengthSymbols. As in the FIG. 6, the duration 602 starts at the third OFDM symbol which is indicated by the parameter sl-StartSymbol and consists of 11 consecutive OFDM symbols which is indicated by the parameter sl-LengthSymbols. For a slot indicated for transmission of S-SS/PSBCH blocks, the first symbol and the number of consecutive symbols is predetermined.

A UE received a PSSCH transmission may transmit sidelink HARQ feedback via PSFCH to another UE which transmitted the PSSCH. Sidelink HARQ feedback can be operated in one of two options. In one option, which can be configured for unicast and groupcast, PSFCH transmits either ACK or NACK using a resource dedicated to a single PSFCH transmitting UE. In another option, which can be configured for groupcast, PSFCH transmits NACK, or no PSFCH signal is transmitted, on a resource that can be shared by multiple PSFCH transmitting UEs. Additionally, in sidelink resource allocation mode 1, a UE which received PSFCH can report sidelink HARQ feedback to gNB via PUCCH or PUSCH.

Sidelink control information is split into two stages, i.e., 1^{st}-stage SCI and 2^{nd}-stage SCI. Specifically, SCI carries on PSCCH is the 1^{st}-stage SCI, which transports sidelink scheduling information. That is, the 1^{st}-stage SCI is sent on PSCCH. The SCI carries on PSSCH is the 2^{nd}-stage SCI, which transports sidelink scheduling information, and/or inter-UE coordination related information. That is, the 2^{nd}-stage SCI is send on PSSCH.

The fields of the 1^{st}-stage SCI formats (e.g., the SCI format 1-A) are mapped to the information bits of the 1^{st}-stage SCI. The SCI format 1-A is used for the scheduling of PSSCH and 2^{nd}-stage SCI on PSSCH.

The SCI format 1-A may include the following fields, e.g., Priority, Frequency resource assignment, Time resource assignment, Resource reservation period, DMRS pattern, 2^{nd}-stage SCI format, Beta_offset indicator, Number of DMRS port, Modulation and coding scheme, Additional MCS table indicator, PSFCH overhead indication, Reserved, Conflict information receiver flag. As above-mentioned, in Mode 1, the UE may obtain the time resource assignment field and the frequency resource assignment field from DCI format 3_0 and include them in SCI format 1-A. In mode 2, the UE may determine the resource allocation for sidelink transmission and generate the time resource assignment field and the frequency resource assignment field in SCI format 1-A.

The fields defined in each of the 2^{nd}-stage SCI formats (e.g., the SCI format 2-A, SCI format 2-B, SCI format 2-C) are mapped to the information bits of the 2^{nd}-stage SCI. The SCI format 2-A is used for the decoding of PSSCH, with HARQ operation when HARQ-ACK information includes ACK or NACK, when HARQ-ACK information includes only NACK, or when there is no feedback of HARQ-ACK information. The SCI format 2-B is used for the decoding of PSSCH, with HARQ operation when HARQ-ACK information includes only NACK, or when there is no feedback of HARQ-ACK information. The SCI format 2-C is used for the decoding of PSSCH, and providing inter-UE coordination information or requesting inter-UE coordination information.

In the present disclosure, a UE 102 (e.g., the reception unit of the UE 102) may be provided a sidelink (SL) BWP by a SL BWP configuration. The SL BWP configuration may provide the UE 102 a SCS of the SL BWP. A SL BWP configuration may include one or more resource pool configurations. For a resource pool within the SL BWP, the UE 102 may determine the SCS of the resource pool is as same as the SCS of the SL BWP. Hereinafter, the terms “SCS of SL BWP” and “SCS of resource pool” can be used interchangeably. The SCS of a SL BWP can be configured as 15 kHz, 30 kHz, or 60 kHz.

In the present disclosure, the SL BWP configuration may be included in a pre-configuration or may be received by the UE 102 from the base station 160. The pre-configuration may be stored by a memory unit of the UE 102 in advance. The memory unit of the UE 102 can be a data buffer 104 or the UE RRC information configuration 126. A reception unit of the UE 102 may receive the SL BWP configuration included in the pre-configuration that is stored in the 102 in advance. Additionally, the reception unit of the UE 102 may receive the SL BWP configuration from the base station 160. The memory unit of the UE 102 may store the SL BWP configuration received from the base station 160 as well. The base station 160 may generate, to the UE 102, a SL BWP configuration indicating a SL BWP and transmit the SL BWP configuration to the UE 102.

In NR Releases 16/17, sidelink communication was developed to support sidelink CSI report for link adaptation. That is, the existing sidelink CSI report provides channel status information for link adaptation to increase the spectral efficiency for sidelink transmissions. For sidelink operation on FR2 licensed spectrum, beam management is a fundamental feature. To support the fundamental feature, it is important to specify a mechanism as to how to report information related to, for example, candidate beam indication(s) and associated beam power. However, the existing developed sidelink CSI reporting method fails to support the sidelink CSI report related to this kind of information. The present disclosure provides new methods and solutions on how to perform sidelink CSI report on FR2 licensed spectrum, which would provide a more efficient and flexible sidelink communication system.

In the present disclosure, the CSI reporting quantities can be CSI-RS resource indicator (CRI), rank indicator (RI), layer indicator (LI), precoder matrix indicator (PMI), channel quality indicator (CQI), reference signal received power (RSRP). One Sidelink CSI report may include or carry a part of the CSI reporting quantities.

For simplicity, in the present disclosure, a requesting UE may refer to a second UE transmitting a SCI format to trigger a sidelink CSI report, while a reporting UE may refer to a first UE receiving a SCI format to trigger a sidelink CSI report.

The CSI reporting quantity, CRI, indicates a specific CSI-RS resource index. A CRI can be regarded as a beam indicator. The CSI reporting quantity, RI, indicates a suitable transmission rank that a reporting UE determines to report. The reporting UE may determine to report or derive a suitable transmission rank based on SINR level by measuring associated sidelink CSI-RS(s). The CSI reporting quantity, LI, indicates a suitable layer where a phase tracking reference signal should be transmitted. The CSI reporting quantity, PMI, indicates a suitable precoder matrix that the reporting UE determines based on the reported RI. The CSI reporting quantity, CQI, indicates a suitable channel coding rate and modulation scheme that the reporting UE determines based on the reported RI and PMI. The CSI reporting quantity RSRP (L1-RSRP) indicates a linear average received power on the resource elements occupied by a CSI-RS.

The reporting UE may derive values of the reporting quantities based on the measurement results of sidelink CSI-RS transmitted by a requesting UE. Specifically, a requesting UE may transmit sidelink CSI-RS within a unicast PSSCH transmission when the request UE triggers a sidelink CSI report. A reporting UE may measure the channel state information based on the sidelink CSI-RS and transmit a sidelink CSI report based on the measurement of the sidelink CSI-RS. Based on the measurement of sidelink CSI-RS, the UE can derive, for example, the value of the rank indicator (RI) and the value of CQI conditioned on the reported RI.

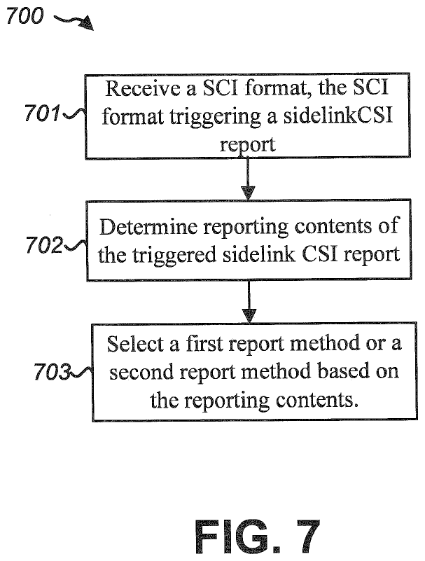

FIG. 7 is a flow diagram illustrating one implementation of a method 700 for determination of CSI reporting by a UE 102. In the present implementation, determination of sidelink CSI reporting and bitwidth determination of a CSI request field are illustrated hereinafter.

The UE 102 can be provided NR sidelink communication (pre-)configuration(s) as above-mentioned. The UE 102 may set the SL BWP configuration according to the stored and/or received SL BWP configuration in the (pre-)configuration(s). The SL BWP configuration provides the UE 102 a SL BWP for sidelink transmission. The SL BWP configuration may include one or more SL resource pool configurations where each of the one or more SL resource pool configurations indicates a SL resource pool in the SL BWP. The UE 102 may refer to a first UE and/or a second UE that are mentioned later.

A first UE may receive 701, from a second UE, a SCI format. The SCI format includes a CSI request field to trigger a sidelink CSI report. The SCI format may be the above-mentioned 2^{nd}-stage SCI format. For example, the SCI format may be the SCI format 2-A or SCI format 2-C. That is, the SCI format 2-A or the SCI format 2-C may include a CSI request field. The second UE transmits a sidelink CSI-RS that are used for measurement. That is, the first UE may receive a sidelink CSI-RS from the second UE. The first UE may perform channel measurement based on the sidelink CSI-RS from the second UE and may feedback the measured information to the second UE.

For example, for CSI acquisition purpose, the first UE may be configured to measure sidelink CSI-RS(s) and may estimate the sidelink channel state based on the CSI-RS measurements. The first UE may generate a sidelink CSI report carrying channel state information (e.g., CQI, RI) and may send the sidelink CSI report to the second UE. On the other hand, for beam reporting purpose, the first UE may be configured to measure sidelink CSI-RS(s) and estimate beam power based on the CSI-RS measurements. The first UE may generate a sidelink CSI report including beam information (e.g., CRI, L1-RSRP) and may send the sidelink CSI report to the second UE.

In the present disclosure, a sidelink CSI reporting for CSI acquisition purpose can be also referred to as a first sidelink CSI reporting and a sidelink CSI reporting for beam management purpose can be also referred to as a second sidelink CSI reporting. A higher layer parameter sl-CSI-Acquisition is used to indicate whether the first sidelink CSI reporting is enabled in sidelink unicast or not. For example, in a case that the parameter sl-CSI-Acquisition is present (or included) in the (pre-)configuration, the UE may determine the first sidelink CSI reporting is enabled in sidelink communication. On the other hand, in a case that the parameter sl-CSI-Acquisition is absent (not included) in the (pre-)configuration, the UE may determine the first sidelink CSI reporting is disabled in sidelink communication.

Likewise, a higher layer parameter sl-CSI-BeamManagement is used to indicate whether the second sidelink CSI reporting is enabled in sidelink unicast or not. For example, in a case that the parameter sl-CSI-BeamManagement is present (included) in the (pre-)configuration, the UE may determine the second sidelink CSI reporting is enabled in sidelink communication. On the other hand, in a case that the higher layer parameter sl-CSI-BeamManagement is absent (not included) in the (pre-)configuration, the UE may determine the second sidelink CSI reporting is disabled in sidelink communication.

Additionally, the first UE may need to notify the second UE of its capabilities for sidelink CSI reporting. The first UE may include corresponding parameters in a capability message and provide the capability message to the second UE. The second UE may trigger a sidelink CSI report according to the first UE's capabilities. For example, a first sidelink CSI report capability indicates the support of the first sidelink CSI report, while a second sidelink CSI report capability indicates the support of the second sidelink CSI report. If the first UE supports both of them, the first UE may include a first parameter indicating the first sidelink CSI report capability and a second parameter indicating the second sidelink CSI report capability in the capability message and provide the capability message to the second UE. If the first UE does not support the second sidelink CSI report capability, the first UE does not include the second parameter indicating the second sidelink CSI report capability in the capability message.

The second UE may use the CSI request field to trigger the sidelink CSI report. For bitwidth determination of the CSI request field, the UE 102 (both the first UE and the second UE) may determine based on (I) whether or not the parameter sl-CSI-Acquisition is present and/or (II) whether or not the parameter sl-CSI-Beam Management is present.

In a case that one of the parameter sl-CSI-Acquisition and the parameter sl-CSI-BeamManagement is present in the (pre-)configuration, the UE 102 may determine the bitwidth of the CSI request field as 1 bit. Then the CSI request field setting to ‘1’ means a corresponding sidelink CSI reporting (i.e., an enabled sidelink CSI reporting according to the presence of its associated parameter) is triggered. Additionally or alternatively, in a case that none of the parameter sl-CSI-Acquisition and the parameter sl-CSI-BeamManagement is present in the (pre-)configuration, the UE 102 may determine the bitwidth of the CSI request field as 1 bit. A requesting UE may not set the CSI request field as ‘1’. Additionally or alternatively, in a case that both of the parameter sl-CSI-Acquisition and the parameter sl-CSI-BeamManagement are present in the (pre-)configuration, the UE 102 may determine the bitwidth of the CSI request field as A bits where the value of A is larger than 1. The number of A bits can be indicated by another higher layer parameter. Or, the number of A bits can be a predefined number that is larger than 1. For example, the predefined number may be 2.

Additionally or alternatively, in a case that the higher layer parameter sl-CSI-BeamManagement is present in the (pre-)configuration, the UE 102 may determine the bitwidth of the CSI request field as B bits. The number of multiple bits can be indicated by a parameter. Additionally or alternatively, the number of B bits can be a predefined number that is larger than 1. For example, the predefined number may be 2.

When both the first sidelink CSI reporting and the second sidelink CSI reporting are enabled (i.e., both of the parameter sl-CSI-Acquisition and the parameter sl-CSI-BeamManagement are present in the (pre-)configuration), the UE 102 may determine which one of the first sidelink CSI reporting and the second sidelink CSI reporting is triggered at least based on codepoints of the CSI request field. Here, for simplicity, a CSI request field with 2 bits is taken as illustration. In a case that the CSI request field indicates a first codepoint (e.g., ‘00’), the UE 102 may determine no sidelink CSI report is triggered. In a case that the CSI request field indicates a second codepoint (e.g., ‘01’), the UE 102 may determine the first sidelink CSI report is triggered. In a case that the CSI request field indicates a third codepoint (‘10’), the UE 102 may determine the second sidelink CSI report is triggered.

According to which one of the first sidelink CSI report and the second sidelink CSI report is triggered, the first UE may determine 702, reporting contents for the triggered sidelink CSI report. In the present disclosure, “a UE determines reporting contents of a triggered CSI report” also implies “a UE determines that a triggered CSI report is a first sidelink CSI report or a second sidelink CSI report”. In other words, the first UE may determine, at least based on codepoints of the CSI request field, the reporting contents of the triggered CSI report.

The first UE may determine 703, based on the reporting contents of the triggered sidelink CSI report, to select a first sidelink CSI reporting method or a second sidelink CSI reporting method. In the present disclosure, “based on report contents of the sidelink CSI report” also refers to “based on whether the triggered CSI report is a first sidelink CSI report or a second sidelink CSI report”.

In a case that reporting contents are the contents of the first sidelink CSI report, the first UE may determine to select a first sidelink CSI reporting method to send the triggered CSI report to the second UE. In other words, in a case that the triggered CSI report is the first sidelink CSI report, the first UE may determine to select the first sidelink CSI reporting method to send the triggered CSI report to the second UE. On the other hand, in a case that the reporting contents are the contents of the second sidelink CSI report, the first UE may determine to select a second sidelink CSI reporting method to send the triggered CSI report to the second UE. In other words, in a case that the triggered CSI report is the second sidelink CSI report, the first UE may determine to select the second sidelink CSI reporting method to send the triggered CSI report to the second UE.

In an example of the implementation of the present disclosure, the first sidelink CSI report is a sidelink CSI report that may consist of CQI and RI, while the second sidelink CSI report is a sidelink CSI report that may include CRI and/or L1-RSRP. That is, the contents of the first sidelink CSI report may include CQI and RI, while the contents of the second sidelink CSI report may include CRI and/or L1-RSRP.

Additionally or alternatively, in an example of the implementation of the present disclosure, in an example of the implementation of the present disclosure, the first sidelink CSI report is a sidelink CSI report that includes CQI and RI and does not include other CSI report quantities, while the second sidelink CSI report is a sidelink CSI report that include at least one CSI quantity that is not either CQI or RI. That is, the contents of the first sidelink CSI report may include CQI and RI and do not include other CSI report quantities, while the contents of the second sidelink CSI report may at least include one CSI quantity that is not the either CQI or RI. For example, the CSI quantity that is not the either CQI or RI can be the L1-RSRP.

Additionally or alternatively, in an example of the implementation of the present disclosure, the first sidelink CSI report is a sidelink CSI report that does not include at least the reporting quantity L1-RSRP, while the second sidelink CSI report is a sidelink CSI report that includes at least the reporting quantity L1-RSRP. In the example, the first sidelink CSI report and the second sidelink CSI report may include same reporting quantities, for example, CRI. That is, the contents of the first sidelink CSI report does not include L1-RSRP, while the contents of the second sidelink CSI report include at least L1-RSRP.

In an example of selecting sidelink CSI reporting method, the first sidelink CSI reporting method is to generate the sidelink CSI report by using a Medium Access Control (MAC) Control Element (CE) with a MAC subheader with a first logical channel ID (LCID) value. The second sidelink CSI reporting method is to generate the CSI report by using a MAC CE with a subheader with a second LCID value. The first LCID value is different from the second LCID value. The MAC CE is transmitted in PSSCH. Specifically, a MAC CE is a portion of a SL-SCH transport block (i.e., a sidelink MAC PDU). Sidelink CSI reporting MAC CE is contained in a sidelink MAC PDU. The first UE may send a MAC PDU in the PSSCH wherein the MAC PDU includes the sidelink CSI reporting MAC CE.

In the present disclosure, the Medium Access Control (MAC) Control Element (CE) with a MAC subheader with a first logical channel ID (LCID) value can also refer to a first sidelink CSI reporting MAC CE that can be identified by the MAC subheader with the first LCID value. Likewise, the MAC CE with a subheader with a second LCID value can also refer to a second sidelink CSI reporting MAC CE that can be identified by the MAC subheader with the second LCID value.

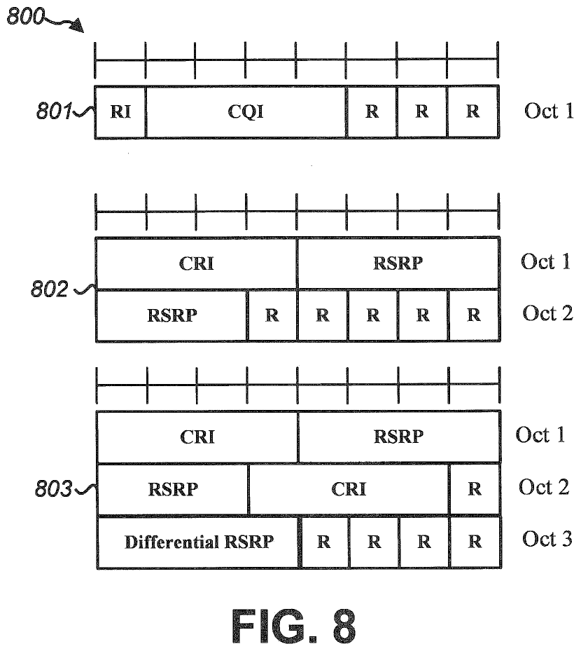

FIG. 8 is a diagram illustrating examples 800 of MAC CEs for sidelink CSI reporting.

In the FIG. 8, the MAC CE 801 is an example of the first sidelink CSI reporting MAC CE that is identified by a MAC subheader with the first LCID value. The MAC CE 801 includes a field of RI with 1 bit, a field of CQI with 4 bit, a field of R with 1 bit. The field of RI indicates the derived value of the rank indicator for sidelink CSI reporting. The field of CQI indicates the derived value of the channel quality indicator for sidelink CSI reporting. The field of R is a reserved bit.

In the FIG. 8, the MAC CE 802 is an example of the second sidelink CSI reporting MAC CE that is identified by a MAC subheader with the second LCID value. The MAC CE 801 includes a field of CRI with 4 bit, a field of RSRP with 7 bit, a field of R with 5 bit. The field of CRI indicates the derived value of the CSI-RS resource indicator for sidelink CSI reporting. The field of RSRP indicates the measured value of L1-RSRP associated with the reported CRI for sidelink CSI reporting. The field of R is a 5 bit-length reserved bits. The measured value of L1-RSRP is quantized to a 7-bit value in the range [−140, −44] dBm with 1 dB step size.

A UE may be configured to report more than 1 combination of CRI and L1-RSRP. In this case, both L1-RSRP and differential L1-RSRP can be reported. The MAC CE 803 is an example of the second sidelink CSI reporting MAC CE where two combinations of CRI and RSRP are carried. A largest measured value of L1-RSRP is reported based on 7-bit value. The differential L1-RSRP is quantized to a 4-bit value. Specifically, the differential L1-RSRP value is computed with 2 dB step size with a reference to the largest measured value of the L1-RSRP.

Noted that in the examples of MAC CE in FIG. 8, the field of CRI is illustrated as 4 bits. The bitwidth determination of CRI field is calculated based on the number of the NZP CSI-RS resources in a corresponding resource set. To be specific, the bitwidth of CRI field is determined as ceiling (log 2(Ks)) where Ks is the number of NZP CSI-RS resources in a corresponding resource set. The second UE may send the PSSCH carrying information related to the CSI-RS configuration, for example, including the number of NZP CSI-RS resources. Upon reception of the PSSCH, the first UE can be aware of the information related to the number of NZP CSI-RS resources and may determine the bitwidth of the CRI field.

In the implementation, the first sidelink CSI reporting MAC CE may have a fixed size, while the second sidelink CSI reporting MAC CE may have a variable size based on the reporting contents. The first sidelink CSI reporting MAC CE may be used to carry CQI and RI. The second sidelink CSI reporting MAC CE may be used to carry the above-mentioned report quantities in addition to CQI and RI. Depending on reporting contents, the second sidelink CSI reporting MAC CE may include a plurality of MAC CE format wherein each MAC CE format corresponds to a combination of the above-mentioned report quantities. In other words, the second sidelink CSI reporting MAC CE may refer to a plurality of second sidelink CSI reporting MAC CEs wherein each second sidelink CSI reporting MAC CE corresponds to a combination of the above-mentioned report quantities for CSI reporting. In general, the first sidelink CSI reporting MAC CE may be used for reporting a combination of CQI and RI, while the second sidelink CSI reporting MAC CEs may be used for reporting combinations of above-mentioned report quantities other than the combination of CQI and RI. The plurality of MAC CE formats (i.e., different second sidelink CSI reporting MAC CEs) can be identified by their respective LCID values included in their associated MAC subheaders. The LCID values used for second sidelink CSI reporting MAC CEs are different from that used for the first sidelink CSI reporting MAC CE. According to different combinations of report quantities, different MAC CE formats (i.e., different second sidelink CSI reporting MAC CEs) may have different sizes. The size of each MAC CE format can be also indicated by a length field in MAC subheader.

For example, as in the FIG. 8, the MAC CE 802, as one kind of second sidelink CSI reporting MAC CEs, corresponds to a combination of CRI and RSRP, while the MAC CE 803, as another kind of second sidelink CSI reporting MAC CEs, corresponds to a combination of CRI, RSRP and L1-RSRP. The MAC CE 801, the first sidelink CSI reporting MAC CE, corresponds to a combination of CQI and RI.

Additionally or alternatively, the first sidelink CSI reporting MAC CE may have a variable size according to the reporting contents of the first sidelink CSI report. For example, the first sidelink CSI report may be configured to carry CRI in addition to CQI and RI. In this case, the size of the first sidelink CSI reporting MAC CE can be indicated by a field of the subheader.

Additionally or alternatively, in an example of selecting sidelink CSI reporting method, the first sidelink CSI reporting method is to generate the sidelink CSI report by using a Medium Access Control (MAC) Control Element (CE) with a MAC subheader with a first logical channel ID (LCID) value, while the second sidelink CSI reporting method is to send the sidelink CSI report in PSSCH by multiplexing the sidelink CSI report in PSSCH. In other words, the second sidelink CSI report and a MAC PDU are multiplexed together in PSSCH. The first UE may send sidelink CSI report and the MAC PDU in the PSSCH to the second UE. Herein, in the example, the first sidelink CSI report is carried in a sidelink MAC CE wherein the sidelink MAC CE is part of the MAC PDU, while the second sidelink CSI report is not carried in a sidelink MAC CE. Instead, the contents (information) of the second sidelink CSI report is send in PSSCH.

When the transmission of the second sidelink CSI report and the transmission of a SL-SCH transport block (a sidelink MAC PDU) coincide in time, the information (reporting contents) of the second sidelink CSI report and the SL-SCH transport block are multiplexed in PSSCH. That is, the multiplexed data of the SL-SCH transport block and information bits of the second sidelink CSI report are sent in the PSSCH. The information (reporting contents) of the second sidelink CSI report is multiplexed by rate matching PSSCH. The UE 102 performs channel coding for information bits of the second sidelink CSI report. Coded bits of the second sidelink CSI report refers to the information bits of the second sidelink CSI report after channel coding. The coded bits of the second sidelink CSI report are multiplexed onto PSSCH.

In the example, for transmission of the second sidelink CSI report on PSSCH with SL-SCH (i.e., sidelink MAC PDU, sidelink transport block), the number of resource elements (or the number of coded modulation symbols) used for transmission of the second sidelink CSI report may be calculated by the UE 102. The UE 102 may determine part of PSSCH resource for transmissions of the 2^{nd}-state SCI format and the second sidelink CSI report, and determine remaining PSSCH resources for transmission of the SL-SCH data (i.e., the sidelink transport block).

Additionally or alternatively, in an example of selecting sidelink CSI reporting method, the first sidelink CSI reporting method is to generate the sidelink CSI report by using a Medium Access Control (MAC) Control Element (CE) with a MAC subheader with a first logical channel ID (LCID) value, while the second sidelink CSI reporting method is to send the sidelink CSI report in PSFCH. That is, in the example, the second sidelink CSI report can be transmitted in PSFCH. The UE 102 may send the second sidelink CSI report via PSFCH. The information (reporting contents) of the sidelink CSI report can be multiplexed in PSFCH.

A MAC PDU for sidelink consists of one SL-SCH subheader and one or more MAC subPDUs. Each MAC subPDU consists one of the followings: (i) a MAC subheader only (including padding), (ii) a MAC subheader and a MAC service data unit (SDU), (iii) a MAC subheader and a MAC CE, and (iv) a MAC subheader and padding. MAC SDUs are of variable sizes. Each MAC subheader except SL-SCH subheader corresponds to either a MAC SDU, a MAC CE, or padding.

A MAC subheader consists of a part of the following fields; (i) a V field, (ii) a SRC field, (iii) a DST field, (iv) a LCID field, (v) a L field, (vi) a F field, and, (vii) a reserved field. The MAC subheader is octet aligned. The V field with 4 bits is the MAC PDU format version number field to indicate which version of the SL-SCH subheader is used. The SRC field with 16 bits carries the 16 most significant bits of the source Layer-2 ID set to the identifier provided by upper layers. The DST field with 8 bits carries the 8 most significant bits of the Destination Layer-2 ID set to the identifier provided by upper layers. The LCID field with 6 bits is used to identify the logical channel instance of the corresponding MAC SDU or the type of the corresponding MAC CE within the scope of one Source Layer-2 ID and Destination Layer-2 ID pair or padding. The L field is a length field to indicate the length of the corresponding MAC SDU or variable-sized MAC CE in bytes. The F field is a format field with 1 bit to indicate the size of the Length field. The value 0 of the F field indicates 8 bits of the Length field and the value 1 of the F field indicates 16 bits of the Length field. The R field includes a reserved bit set to 0. The MAC subheader is octet aligned.

The SL-SCH subheader is of fixed size and consists of the seven header fields V/R/R/R/R/SRC/DST. A MAC subheader except for fixed-sized MAC CE and padding consists of the four header fields R/F/LCID/L. A MAC subheader for fixed-sized MAC CE and padding consists of the two header fields R/LCID.

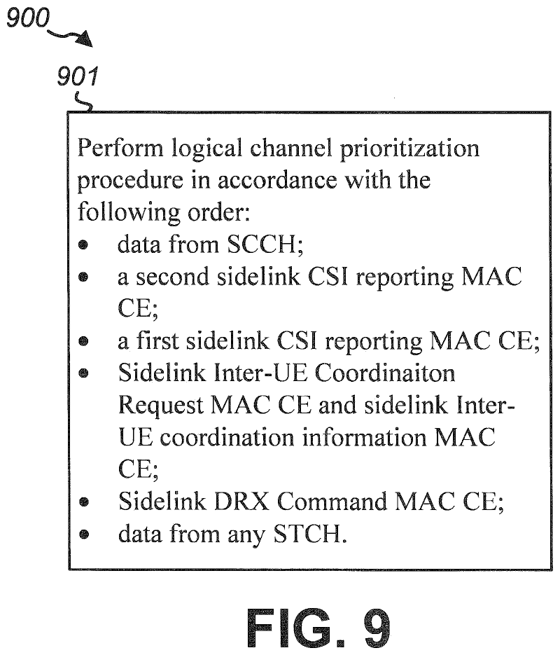

FIG. 9 is a diagram illustrating one implementation of a method 900 for priority determination for two sidelink CSI reporting MAC CEs by a UE 102. In the implementation, the first UE may perform a sidelink logical channel prioritization procedure. The sidelink logical channel prioritization procedure is used to ensure that the sidelink data is sent by the UE according to its priority. Whenever a UE performs a new sidelink transmission in allocated PSSCH resources, the UE 102 may apply the logical channel prioritization procedure.

The UE 102 (i.e. the processor 1081 of the UE 102) may perform 901, the sidelink logical channel prioritization procedure in accordance with the order as specified in FIG. 9. In the FIG. 9, a highest priority is listed first. The UE 102 may determine that data from sidelink control channel (SCCH) has a highest priority. Herein, sidelink control channel is a sidelink channel for transmitting control information (i.e. PC5-RRC and PC5-S messages) from one UE to other UE(s).

The UE 102 (i.e. the processor 1081 of the UE 102) may determine, for the SL logical channel prioritization procedure, a priority order between the first sidelink CSI reporting MAC CE and the second sidelink CSI reporting MAC CE. The first sidelink CSI reporting MAC CE and the second sidelink CSI reporting MAC CE are illustrated in the above implementation 700. The UE 102 may determine that, the second sidelink CSI reporting MAC CE is prioritized over the first SL CSI reporting MAC CE. As above-mentioned, the second sidelink CSI reporting MAC CE may carry beam information, for example, L1-RSRP and/or CRI. The second sidelink CSI reporting MAC CE may carry beam information and channel state information, while the first sidelink CSI reporting MAC CE may carry channel state information. The benefit of prioritizing the second sidelink CSI reporting MAC CE over the first sidelink CSI reporting MAC CE lies in the fact that there is more change for beam information to be allocated in the PSSCH resource for transmission. The beam information contributes to maintaining reliable sidelink between the first UE and the second UE. Therefore, a more efficient and reliable SL transmission over FR2 licensed spectrum can be provided.

In the sidelink logical channel prioritization procedure, the UE 102 (i.e. the processor 1081 of the UE 102) may determine to prioritize a MAC CE carrying at least L1-RSRP over a MAC CE not carrying L1-RSRP. In other words, the UE 102 may determine to prioritize a MAC CE carrying at least L1-RSRP over a MAC CE carrying CQI and RI. In other words, the UE 102 may determine to prioritize a MAC CE carrying L1-RSRP and CQI and RI over a MAC CE carrying CQI and RI. Among multiple sidelink MAC CEs, the UE 102 may determine that a MAC CE carrying L1-RSRP has a highest priority.

In the sidelink logical channel prioritization procedure, the UE 102 (i.e. the processor 1081 of the UE 102) may determine to prioritize a MAC CE carrying at least CRI over a MAC CE not carrying CRI. In other words, the UE 102 may determine to prioritize a MAC CE carrying at least CRI over a MAC CE carrying CQI and RI. In other words, the UE 102 may determine to prioritize a MAC CE carrying CRI and CQI and RI over a MAC CE carrying CQI and RI. Among multiple sidelink MAC CEs, the UE 102 may determine that a MAC CE carrying CRI has a highest priority.

In the sidelink logical channel prioritization procedure, the UE 102 (i.e. the processor 1081 of the UE 102) may determine to prioritize a MAC CE carrying at least RSRP over a MAC CE not carrying RSRP. In other words, the UE 102 may determine to prioritize a MAC CE carrying at least RSRP over a MAC CE carrying CQI and RI. In other words, the UE 102 may determine to prioritize a MAC CE carrying RSRP and CQI and RI over a MAC CE carrying CQI and RI. Among multiple sidelink MAC CEs, the UE 102 may determine that a MAC CE carrying RSRP has a highest priority.

In the sidelink logical channel prioritization procedure, the UE 102 (i.e. the processor 1081 of the UE 102) may determine to prioritize a MAC CE carrying at least CRI and L1-RSRP over a MAC CE not carrying CRI and L1-RSRP. In other words, the UE 102 may determine to prioritize a MAC CE carrying at least CRI and L1-RSRP over a MAC CE carrying CQI and RI. In other words, the UE 102 may determine to prioritize a MAC CE carrying CRI and L1-RSRP and CQI and RI over a MAC CE carrying CQI and RI. Among multiple sidelink MAC CEs, the UE 102 may determine that a MAC CE carrying CRI and L1-RSRP has a highest priority.

For sidelink inter-UE coordination request MAC CE and sidelink Inter-UE coordination information MAC CE, the UE 102 may determine that their priorities are lower than sidelink CSI reporting MAC CE but higher than the sidelink DRX command MAC CE.

Lastly, the UE 102 may determine the data from any sidelink traffic channel (STCH) has the lowest priority. Sidelink traffic channel is a sidelink channel for transmitting user information from one UE to other UE(s).

In the implementation, data from SCCH, sidelink MAC CE(s), data from STCH are mapped to SL-SCH. That is, the data from SCCH, sidelink MAC CE(s), data from STCH may be contained in a sidelink MAC PDU. Each above-mentioned sidelink MAC CE can be identified by its MAC subheader with LCID.

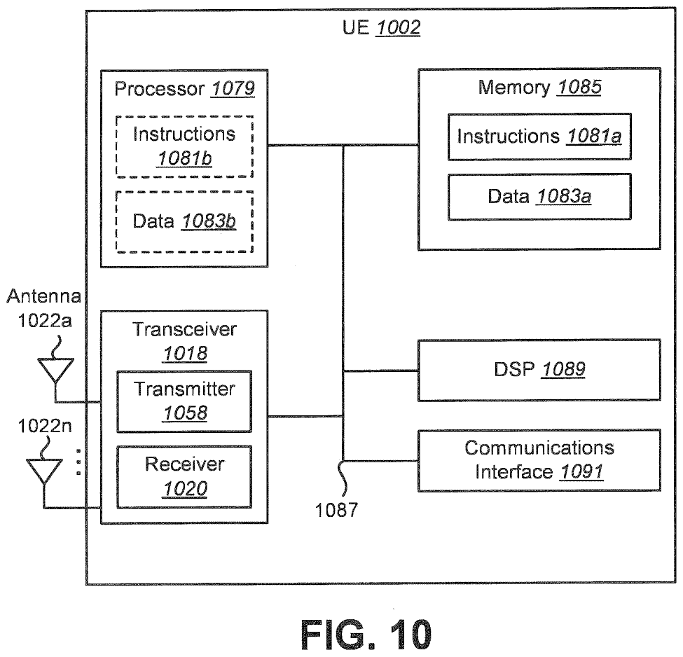

FIG. 10 illustrates various components that may be utilized in a UE 1002. The UE 1002 (UE 102) described in connection with FIG. 10 may be implemented in accordance with the UE 102 described in connection with FIG. 1. The UE 1002 includes a processor 1081 that controls operation of the UE 1002. The processor 1081 may also be referred to as a central processing unit (CPU). Memory 1087, which may include read-only memory (ROM), random access memory (RAM), a combination of the two or any type of device that may store information, provides instructions 1083a and data 1085a to the processor 1081. A portion of the memory 1087 may also include non-volatile random access memory (NVRAM). Instructions 1083b and data 1085b may also reside in the processor 1081. Instructions 1083b and/or data 1085b loaded into the processor 1081 may also include instructions 1083a and/or data 1085a from memory 1087 that were loaded for execution or processing by the processor 1081. The instructions 1083b may be executed by the processor 1081 to implement one or more of the methods described above.

The UE 1002 may also include a housing that contains one or more transmitters 1058 and one or more receivers 1020 to allow transmission and reception of data. The transmitter(s) 1058 and receiver(s) 1020 may be combined into one or more transceivers 1018. One or more antennas 1022a-n are attached to the housing and electrically coupled to the transceiver 1018.

The various components of the UE 1002 are coupled together by a bus system 1089, which may include a power bus, a control signal bus and a status signal bus, in addition to a data bus. However, for the sake of clarity, the various buses are illustrated in FIG. 10 as the bus system 1089. The UE 1002 may also include a digital signal processor (DSP) 1091 for use in processing signals. The UE 1002 may also include a communications interface 1093 that provides user access to the functions of the UE 1002. The UE 1002 illustrated in FIG. 10 is a functional block diagram rather than a listing of specific components.

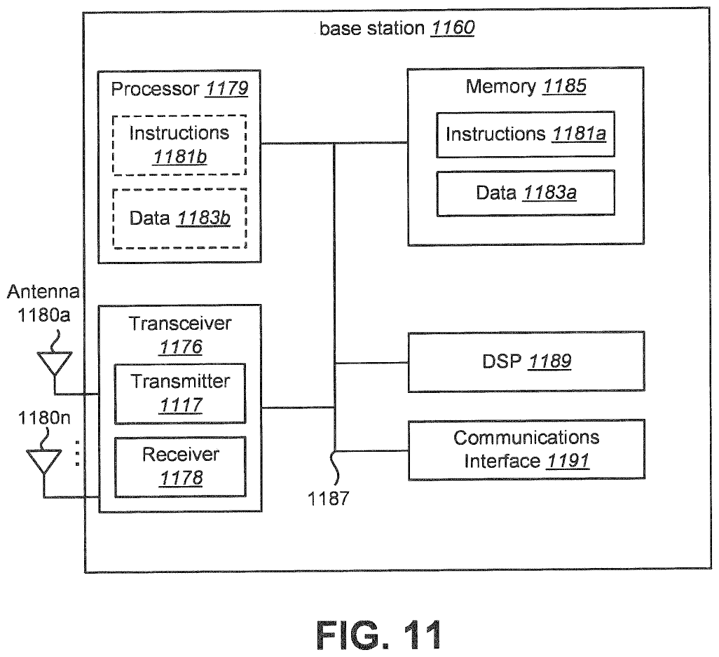

FIG. 11 illustrates various components that may be utilized in a base station 1160. The base station 1160 described in connection with FIG. 11 may be implemented in accordance with the base station 160 described in connection with FIG. 1. The base station 1160 includes a processor 1181 that controls operation of the base station 1160. The processor 1181 may also be referred to as a central processing unit (CPU). Memory 1187, which may include read-only memory (ROM), random access memory (RAM), a combination of the two or any type of device that may store information, provides instructions 1183a and data 1185a to the processor 1181. A portion of the memory 1187 may also include non-volatile random access memory (NVRAM). Instructions 1183b and data 1185b may also reside in the processor 1181. Instructions 1183b and/or data 1185b loaded into the processor 1181 may also include instructions 1183a and/or data 1185a from memory 1187 that were loaded for execution or processing by the processor 1181. The instructions 1183b may be executed by the processor 1181 to implement one or more of the methods 300 described above.

The base station 1160 may also include a housing that contains one or more transmitters 1117 and one or more receivers 1178 to allow transmission and reception of data. The transmitter(s) 1117 and receiver(s) 1178 may be combined into one or more transceivers 1176. One or more antennas 1180a-n are attached to the housing and electrically coupled to the transceiver 1176.

The various components of the base station 1160 are coupled together by a bus system 1189, which may include a power bus, a control signal bus and a status signal bus, in addition to a data bus. However, for the sake of clarity, the various buses are illustrated in FIG. 11 as the bus system 1189. The base station 1160 may also include a digital signal processor (DSP) 1191 for use in processing signals. The base station 1160 may also include a communications interface 1193 that provides user access to the functions of the base station 1160. The base station 1160 illustrated in FIG. 11 is a functional block diagram rather than a listing of specific components.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using circuitry, a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods and apparatus described herein without departing from the scope of the claims.

1. A user equipment (UE), comprising:
a processor and a memory configured to,
perform a sidelink (SL) logical channel prioritization procedure, and,
determine, in the SL logical channel prioritization procedure, a priority order between a first SL CSI reporting Medium Access Control Element (MAC CE) and a second SL CSI reporting MAC CE, the first SL CSI reporting MAC CE carrying channel quality indicator (CQI) and rank indicator (RI) and the second SL CSI reporting MAC CE carrying at least a report quantity other than the CQI and the RI, wherein
the second SL CSI reporting MAC CE is prioritized over the first SL CSI reporting MAC CE.

2. The UE according to the claim 1: wherein
the second SL CSI reporting MAC CE carries at least a report quantity RSRP.

3. A communication method performed by a user equipment (UE), comprising:
performing a sidelink (SL) logical channel prioritization procedure; and
determining, in the SL logical channel prioritization procedure, a priority order between a first SL CSI reporting Medium Access Control Element (MAC CE) and a second SL CSI reporting MAC CE, the first SL CSI reporting MAC CE carrying channel quality indicator (CQI) and rank indicator (RI) and the second SL CSI reporting MAC CE carrying at least a report quantity other than the CQI and the RI, wherein
the second SL CSI reporting MAC CE is prioritized over the first SL CSI reporting MAC CE.
